(19) United States
(12) Patent Application Publication
(10) Pub. No.: US 2014/0232629 A1
(43) Pub. Date: Aug. 21, 2014

(54) METHOD OF DRIVING ELECTROPHORETIC DISPLAY DEVICE, CONTROL CIRCUIT OF ELECTROPHORETIC DISPLAY DEVICE, ELECTROPHORETIC DISPLAY DEVICE, AND ELECTRONIC APPARATUS

(71) Applicant: SEIKO EPSON CORPORATION, Tokyo (JP)

(72) Inventors: Takashi AOKI, Suwa-shi (JP); Mitsutoshi MIYASAKA, Suwa-shi (JP)

(73) Assignee: SEIKO EPSON CORPORATION, Tokyo (JP)

(21) Appl. No.: 14/179,181

(22) Filed: Feb. 12, 2014

(30) Foreign Application Priority Data
Feb. 18, 2013 (JP) 2013-028667

(51) Int. Cl. G09G 3/34

(52) U.S. Cl. CPC G09G 3/344
USPC 345/107

(57) ABSTRACT

An electrophoretic display device includes pixel electrodes, common electrodes, an electrophoretic material, and storage capacity elements. An EPD capacity is sufficiently smaller than a storage capacity. The electrophoretic material includes first particles and second particles. Electric fields, which are generated between the pixel electrodes and the common electrodes when the first particles are dispersed in the vicinity of the common electrodes, include alternate electric fields in which a first strong electric field which faces a first direction and a second weak electric field which is weaker than the first strong electric field are alternately repeated at a common potential cycle. In this way, the first particles are effectively separated from the second particles, and thus the electrophoretic display device, which has a high contrast ratio and which shows high image quality, is implemented.

### BACKGROUND

1. Technical Field

The present invention relates to a method of driving an electrophoretic display device, a control circuit of an electrophoretic display device, an electrophoretic display device, and an electronic apparatus.

2. Related Art

As disclosed in JP-A-2009-175492, in an electrophoretic display device, an image is formed on a display unit by applying a voltage between pixel electrodes and common electrodes which face each other while interposing an electrophoretic material therebetween and by moving electrophoretic particles, such as black-color charged particles or white-color charged particles. As a method of driving such an electrophoretic display device, a plurality of frame periods are provided in order to form one image, common potential is supplied to the common electrodes, and first potential VH or second potential VL, which is lower than the first potential, is supplied to the pixel electrodes in each of the frame periods. At this time, in a single frame period, the common potential is fixed to third potential VH or fourth potential VL which is lower than the third potential.

However, the method of driving an electrophoretic display device according to the related art has a problem of causing a low contrast ratio. More specifically, in an electrophoretic display device according to the related art, reflectance (white reflectance) acquired when white display is performed is approximately 42% and reflectance (black reflectance) acquired when black display is performed is approximately 7%. As a result, a contrast ratio which is a ratio of the white reflectance to the black reflectance is low, that is, approximately 6. In other words, the method of driving an electrophoretic display device according to the related art has a problem in that it is difficult to implement an electrophoretic display device which has a high contrast ratio and which shows high image quality.

### SUMMARY

An advantage of some aspects of the invention can be implemented as the following forms or application examples.

### Application Example 1

According to this application example, there is provided a method of driving an electrophoretic display device that includes pixel electrodes, common electrodes, and an electrophoretic material to which electric fields generated between the pixel electrodes and the common electrodes are applied, and that displays at least a first color and a second color. The electrophoretic material includes first particles which show the first color and second particles which show the second color, at least one side of the first particles and the second particles being charged with positive polarity or negative polarity. When the first particles are dispersed on sides of the common electrodes, the electric fields which are generated between the pixel electrodes and the common electrodes include a first electric field which faces a first direction and a second electric field which is weaker than the first electric field, the first electric field and the second electric field being alternately repeated at a common potential cycle T_{c}. When the second particles are dispersed on sides of the common electrodes, the electric fields which are generated between the pixel electrodes and the common electrodes include a third electric field which faces a second direction opposite to the first direction and a fourth electric field which is weaker than the third electric field, the third electric field and the fourth electric field being repeated at the common potential cycle T_{c}. The first electric field, the second electric field, the third electric field, and the fourth electric field are formed by supplying alternate potential to the common electrodes at the common potential cycle T_{c}.

In this case, the first particles are effectively separated from the second particles, and thus it is possible to implement an electrophoretic display device which has a high contrast ratio and which displays high image quality.

### Application Example 2

In the method of driving an electrophoretic display device according to the application example, it is preferable that, when it is assumed that a period in which one frame image is formed is a frame cycle T_{F}, the common potential cycle T_{c} be shorter than the frame cycle T_{F}.

In this case, since the first particles are effectively separated from the second particles and the common potential cycle T_{c} is short, it is difficult that screen flicker(flicker) is generated. That is, it is possible to implement an electrophoretic display device which has a high contrast ratio and which displays a high-quality image.

### Application Example 3

In the method of driving an electrophoretic display device according to the application example, it is preferable that an orientation of the second electric field be the second direction and an orientation of the fourth electric field be the first direction.

In this case, since the orientation of the first electric field is opposite to the orientation of the second electric field and the orientation of the third electric field is opposite to the orientation of the fourth electric field, it is possible to effectively separate the first particles from the second particles, and thus it is possible to implement an electrophoretic display device which has a high contrast ratio and which displays an high-quality image.

### Application Example 4

In the method of driving an electrophoretic display device according to the application example, it is preferable that an orientation of the second electric field is the first direction, and an orientation of the fourth electric field is the second direction.

In this case, the orientation of the first electric field is the same as the orientation of the second electric field and the orientation of the third electric field is the same as the orientation of the fourth electric field. Accordingly, when the first particles are dispersed in the vicinity of the common electrodes, the average time value of the electric fields which are generated between the pixel electrodes and the common electrodes becomes large. In the same manner, when the second particles are dispersed in the vicinity of the common electrodes, the average time value of the electric fields which are generated between the pixel electrodes and the common electrodes becomes large. Therefore, even when the electrophoretic display device is driven by a comparatively low voltage, it is possible to implement an electrophoretic display device which has a high contrast ratio and which displays a high-quality image.

### Application Example 5

In the method of driving an electrophoretic display device according to the application example, it is preferable that the first particles be charged with negative polarity rather than the second particles, and that first low potential L₁ be supplied to the pixel electrodes when the first particles are dispersed in vicinity of the common electrodes and a relational expression of Expression 1 be satisfied when it is assumed that a central potential of the alternate potential is first middle potential M₁ and an amplitude of the alternate potential is an amplitude V_{A}.

0<M₁−L₁<V_{A} (1)

In this case, it is possible to disperse the first particles which are more strongly charged with negative polarity in the vicinity of the common electrode. Accordingly, when the user views the electrophoretic display device from the sides of the common electrodes, it is possible to recognize the first color which is shown by the first particles. When the electrophoretic display device is viewed from the sides of the pixel electrodes, it is possible to recognize the second color which is shown by the second particles.

### Application Example 6

In the method of driving an electrophoretic display device according to the application example, it is preferable that the first particles be charged with positive polarity rather than the second particles, and that first low potential L₁ be supplied to the pixel electrodes when the first particles are dispersed in vicinity of the common electrodes and a relational expression of Expression 2 be satisfied when it is assumed that a central potential of the alternate potential is first middle potential M₁ and an amplitude of the alternate potential is an amplitude V_{A}.

0<L₁−M₁<V_{A} (2)

In this case, it is possible to disperse the first particles which are more strongly charged with positive polarity in the vicinity of the common electrodes. Accordingly, when the user views the electrophoretic display device from the sides of the common electrodes, it is possible to recognize the first color which is shown by the first particles. When the electrophoretic display device is viewed from the sides of the pixel electrodes, it is possible to recognize the second color which is shown by the second particles.

### Application Example 7

In the method of driving an electrophoretic display device according to the application example, it is preferable that the first particles be charged with negative polarity rather than the second particles, and that first low potential L₁ be supplied to the pixel electrodes when the first particles are dispersed in vicinity of the common electrodes and a relational expression of Expression 3 be satisfied when it is assumed that a central potential of the alternate potential is first middle potential M₁ and an amplitude of the alternate potential is an amplitude V_{A}.

0<V_{A}<M₁−L₁ (3)

In this case, it is possible to disperse the first particles which are more strongly charged with negative polarity in the vicinity of the common electrodes. Accordingly, when the user views the electrophoretic display device from the sides of the common electrodes, it is possible to recognize the first color which is shown by the first particles. When the electrophoretic display device is viewed from the sides of the pixel electrodes, it is possible to recognize the second color which is shown by the second particles.

### Application Example 8

In the method of driving an electrophoretic display device according to the application example, it is preferable that the first particles be charged with positive polarity rather than the second particles, and that first low potential L₁ be supplied to the pixel electrodes when the first particles are dispersed in vicinity of the common electrodes and a relational expression of Expression 4 be satisfied when it is assumed that a central potential of the alternate potential is first middle potential M₁ and an amplitude of the alternate potential is an amplitude V_{A}.

0<V_{A}<L₁−M₁ (4)

In this case, it is possible to disperse the first particles which are more strongly charged with positive polarity in the vicinity of the common electrodes. Accordingly, when the user views the electrophoretic display device from the sides of the common electrodes, it is possible to recognize the first color which is shown by the first particles. When the electrophoretic display device is viewed from the sides of the pixel electrodes, it is possible to recognize the second color which is shown by the second particles.

### Application Example 9

In the method of driving an electrophoretic display device according to the application example, it is preferable that first high potential H₁ be supplied to the pixel electrodes when the second particles are dispersed in vicinity of the common electrodes, and that a relational expression of Expression 5 be satisfied when it is assumed that a central potential of the alternate potential is second middle potential M₂,

0<H₁−M₂<V_{A} (5)

In this case, it is possible to disperse the first particles which are more strongly charged with negative polarity in the vicinity of the pixel electrodes vicinity. Accordingly, when the user views the electrophoretic display device from the sides of the common electrodes, it is possible to recognize the second color which is shown by the second particles. When the electrophoretic display device is viewed from the sides of the pixel electrodes, it is possible to recognize the first color which is shown by the first particles.

### Application Example 10

In the method of driving an electrophoretic display device according to the application example, it is preferable that first high potential H₁ be supplied to the pixel electrodes when the second particles are dispersed in vicinity of the common electrodes, and that a relational expression of Expression 6 be satisfied when it is assumed that a central potential of the alternate potential is second middle potential M₂.

0<M₂−H₁<V_{A} (6)

In this case, it is possible to disperse the first particles which are more strongly charged with positive polarity in the vicinity of the pixel electrodes. Accordingly, when the user views the electrophoretic display device from the sides of the common electrodes, it is possible to recognize the second color which is shown by the second particles. When the electrophoretic display device is viewed from the sides of the pixel electrodes, it is possible to recognize the first color which is shown by the first particles.

### Application Example 11

In the method of driving an electrophoretic display device according to the application example, it is preferable that first high potential H₁ be supplied to the pixel electrodes when the second particles are dispersed in vicinity of the common electrodes, and that a relational expression of Expression 7 be satisfied when it is assumed that a central potential of the alternate potential is second middle potential M₂.

0<V_{A}<H₁−M₂ (7)

In this case, it is possible to disperse the first particles which are more strongly charged with negative polarity in the vicinity of the pixel electrodes. Accordingly, when the user views the electrophoretic display device from the sides of the common electrodes, it is possible to recognize the second color which is shown by the second particles. When the electrophoretic display device is viewed from the sides of the pixel electrodes, it is possible to recognize the first color which is shown by the first particles.

### Application Example 12

In the method of driving an electrophoretic display device according to the application example, it is preferable that first high potential H₁ be supplied to the pixel electrodes when the second particles are dispersed in vicinity of the common electrodes, and that a relational expression of Expression 8 be satisfied when it is assumed that a central potential of the alternate potential is second middle potential M₂.

0<V_{A}<M₂−H₁ (8)

In this case, it is possible to disperse the first particles which are more strongly charged with positive polarity in the vicinity of the pixel electrodes. Accordingly, when the user views the electrophoretic display device from the sides of the common electrodes, it is possible to recognize the second color which is shown by the second particles. When the electrophoretic display device is viewed from the sides of the pixel electrodes, it is possible to recognize the first color which is shown by the first particles.

### Application Example 13

In the method of driving an electrophoretic display device according to the application example, it is preferable that the first middle potential M₁ be equal to the second middle potential M₂.

In this case, it is possible to display the first color, the second color, and the middle grayscale color therebetween for every pixel in a single frame period (one-image display). If the driving method is used, when an image which is being displayed is rewritten and only a part of the image is changed, it is possible to partially rewrite an image corresponding to the changed part.

### Application Example 14

In the method of driving an electrophoretic display device according to the application example, it is preferable that the electrophoretic display device include storage capacity elements, that the storage capacity elements each include first electrodes and second electrodes and the first electrodes be electrically connected to the pixel electrodes, that capacity (EPD capacity C_{E}), which is formed of the pixel electrodes, the common electrodes and the electrophoretic material, be sufficiently smaller than the capacity (storage capacity C_{S}) of the storage capacity element, and that potential of the second electrodes be fixed.

In this case, it is possible to generate alternate electric fields between the pixel electrodes and the common electrodes.

### Application Example 15

According to this application example, there is provided a control circuit of an electrophoretic display device which performs the driving method according to any one of the application examples.

In this case, it is possible to provide a control circuit which displays a high-quality image having a high contrast ratio on an electrooptic device.

### Application Example 16

According to this application example, there is provided an electrophoretic display device which includes the control circuit according to the application example.

In this case, it is possible to provide an electro-optic device which has a high contrast ratio and which displays a high-quality image.

### Application Example 17

According to this application example, there is provided an electronic apparatus which includes the electrophoretic display device according to the application example.

In this case, it is possible to provide an electronic apparatus that includes an electro-optic device which has a high contrast ratio and which displays a high-quality image.

### BRIEF DESCRIPTION OF THE DRAWINGS

The invention will be described with reference to the accompanying drawings, wherein like numbers reference like elements.

FIG. 1 is a perspective view illustrating an electronic apparatus according to the invention.

FIG. 2 is a block diagram illustrating an electronic apparatus according to the embodiment for each functional block.

FIGS. 3A and 3B are circuit block configuration diagrams according to the first embodiment.

FIG. 4 is a view illustrating a sectional configuration of a pixel.

FIG. 5 is a view illustrating an example of a method of driving the electrophoretic display device.

FIG. 6 is a perspective view illustrating the configuration of electronic paper.

FIG. 7 is a perspective view illustrating the configuration of an electronic note.

FIG. 8 is a view illustrating a method of driving an electrophoretic display device according to a second embodiment.

FIG. 9 is a view illustrating a method of driving an electrophoretic display device according to a third embodiment.

FIG. 10 is a view illustrating a method of driving an electrophoretic display device according to a fourth embodiment.

FIG. 11 is a view illustrating a method of driving an electrophoretic display device according to a first modification example.

FIG. 12 is a view illustrating a method of driving an electrophoretic display device according to a second modification example.

### DESCRIPTION OF EXEMPLARY EMBODIMENTS

Hereinafter, embodiments of the invention will be described with reference to the accompanying drawings. Meanwhile, since each layer or each member has a size in a recognizable degree in each of the drawings below, the scale of each layer or each member is different from the actual scale.

### First Embodiment

### Outline of Electronic Apparatus

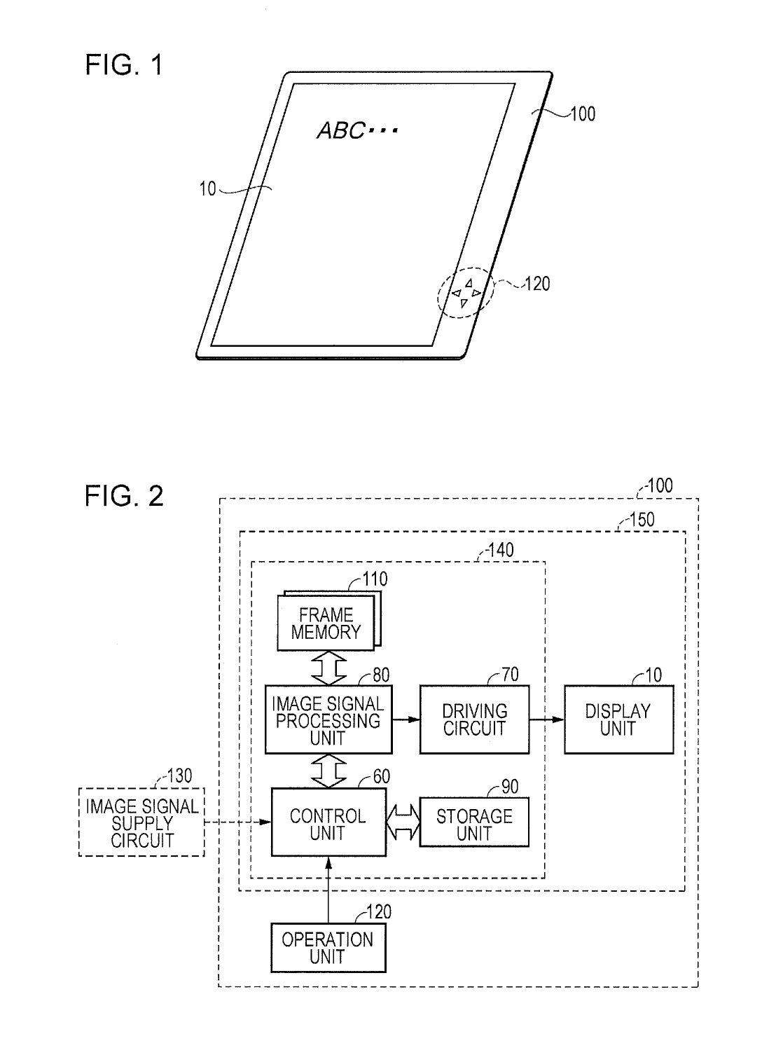

First, the whole configuration (outline) of an electronic apparatus according to a first embodiment will be described with reference to FIG. 1.

FIG. 1 is a perspective view illustrating an electronic apparatus according to the invention.

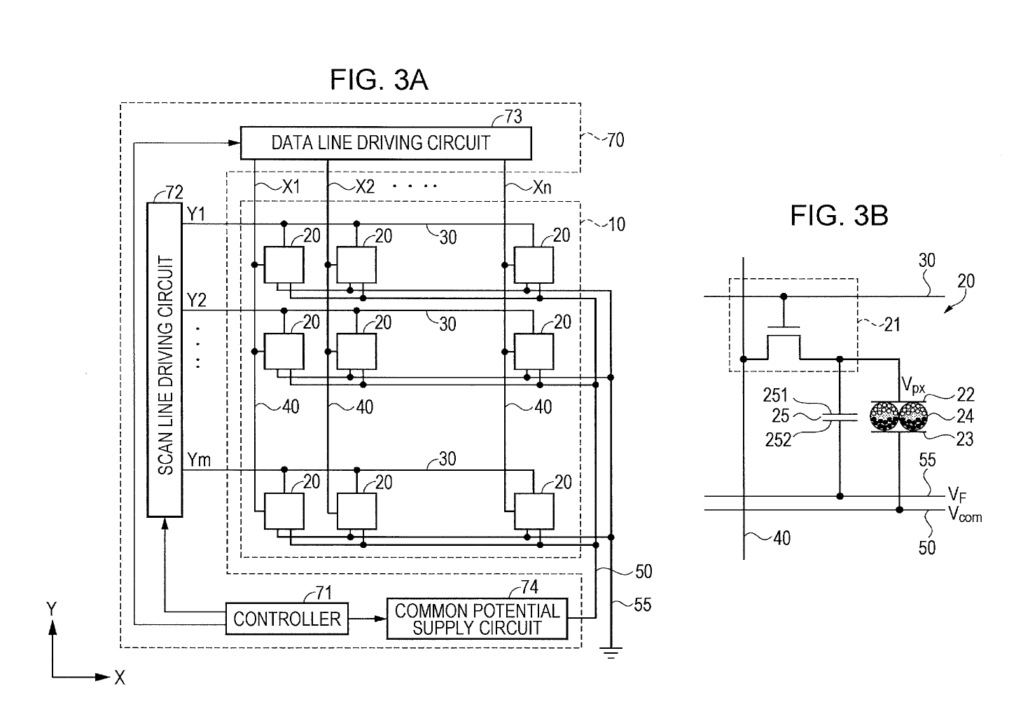

An electronic apparatus 100 according to the invention includes an electrophoretic display device 150 (refer to FIG. 2) and an interface to operate the electronic apparatus 100. More specifically, the interface is an operation unit 120 and includes switches. The electrophoretic display device 150 is a display module which includes a display unit 10. The display unit 10 includes a plurality of pixels 20 (refer to FIG. 3A), and an image is displayed on the display unit 10 in such a way that the pixels 20 are electrically controlled. In the electrophoretic display device 150, display is performed using an electrophoretic material 24 (refer to FIG. 3B).

### Basic Configuration of Electronic Apparatus

FIG. 2 is a block diagram illustrating the electronic apparatus according to the embodiment for each functional block.

The electronic apparatus 100 includes the electrophoretic display device 150 and the operation unit 120. According to a situation, the electronic apparatus 100 may further include an image signal supply circuit 130. The operation unit 120 is a section in which a user operates the electronic apparatus 100. The electrophoretic display device 150 includes the display unit 10 and a control circuit 140. Further, the electrophoretic display device 150 may include the operation unit 120. The control circuit 140 is configured to include a driving circuit 70, a control unit 60, a storage unit 90, an image signal processing unit 80, and a frame memory 110 as a suitable example. The driving circuit 70 supplies various signals, such as a scan line selection signal and an image signal, to the display unit 10. The storage unit 90 stores image data to be displayed on the display unit. The image signal processing unit 80 supplies various signals, such as the image signal, to the driving circuit 70. The control unit 60 controls the above units. Also, the basic configuration of the electronic apparatus according to the embodiment is not limited to the above-described configuration, and a circuit configuration which can implement the driving method according to the embodiment may be used.

The control unit 60 is a Central Processing Unit (CPU), and controls the operation of each unit. In addition, the storage unit 90 is attached to the control unit 60. The storage unit 90 is configured to include, for example, a non-volatile storage device, such as a flash memory. Various image data to be displayed on the display unit 10, various programs to determine the operation of the electronic apparatus 100, and a look-up table are stored in the storage unit 90. The data is input from the external image signal supply circuit 130, and is replaced if necessary. Also, since data which is mainly replaced is an image signal, the image signal supply circuit 130 is named in this manner. However, it is possible to replace the above-described various programs or the look-up table through the image signal supply circuit 130. The image signal supply circuit 130 is provided in a personal computer or a mobile phone, which is connected to the Internet, an USB memory or an SD card, and is configured to supply new data to the electronic apparatus 100. As described above, the electronic apparatus 100 may include the image signal supply circuit 130, and connection to the Internet or a mobile phone network may be made in a unit of an electronic apparatus 100.

The image signal processing unit 80 is attached with the frame memory 110, manufactures an image signal depending on the image data which is taken from the storage unit 90, and supplies the image signal to the driving circuit 70. More specifically, the image signal processing unit 80 and the control unit 60 generate an image signal corresponding to a second image based on an image signal corresponding to a first image (an image which is currently displayed) which is stored in the frame memory 110 and data of the second image (an image which will be subsequently displayed) which is stored in the storage unit 90. The image signal processing unit 80 supplies the image signal which is acquired as described above to the driving circuit 70, and displays the second image on the display unit 10. Also, the frame memory 110 is a Video Random Access Memory (VRAM) which includes memory capacity capable of storing image data corresponding to at least one or more frames of the display unit 10. It is preferable to include the memory capacity corresponding to two or more frames.

The operation unit 120 is configured to include a plurality of operation buttons (refer to FIG. 1), and a user applies a trigger signal to the electronic apparatus 100 in order to change the display using the operation buttons.

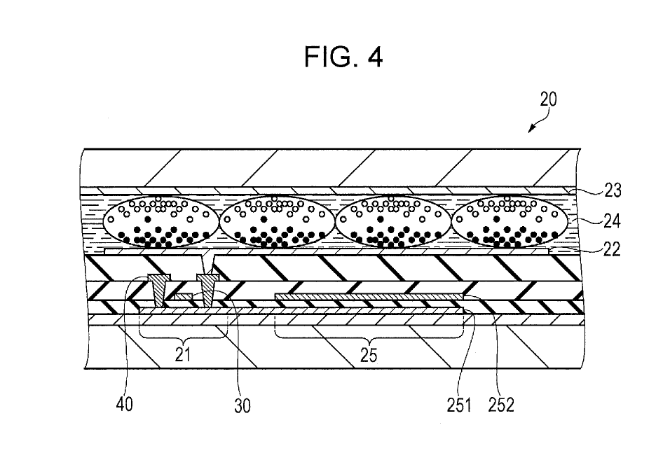

FIG. 3A is a circuit block configuration diagram illustrating the configurations of the display unit and the driving circuit of the electrophoretic display device according to the embodiment, and FIG. 3B is an equivalent circuit diagram illustrating the electrical configuration of a pixel. In addition, FIG. 4 is a view illustrating the sectional structure of a pixel. Subsequently, the configurations of the display unit and the driving circuit of the electrophoretic display device according to the embodiment and the sectional structure will be described with reference to FIGS. 3A to 4.

As shown in FIG. 3A, pixels 20 corresponding to m rows×n columns are arranged in a matrix (two dimensional plane) in the display unit 10. In addition, m scan lines 30 (that is, scan lines Y1, Y2, . . . , Ym) and n data lines 40 (that is, data lines X1, X2, . . . , Xn) are provided to cross each other in the display unit 10. More specifically, the m scan lines 30 extend in the row direction (that is, X direction), and the n data lines 40 extend in the column direction (that is, Y direction). The pixels 20 are arranged to correspond to the intersections of the m scan lines 30 and the n data lines 40.

The driving circuit 70 is attached to the display unit 10. The driving circuit 70 includes a controller 71, a scan line driving circuit 72, a data line driving circuit 73, and a common potential supply circuit 74. The controller 71 controls the operations of the scan line driving circuit 72, the data line driving circuit 73 and the common potential supply circuit 74, and supplies various signals, such as a clock signal and a timing signal, to each of the circuits.

The scan line driving circuit 72 sequentially supplies scan signals to the respective scan lines Y1, Y2, . . . , Ym in a pulse-like manner based on a timing signal which is supplied from the controller 71. The data line driving circuit 73 supplies image signals to the respective data lines X1, X2, . . . , Xn based on the timing signal which is supplied from the controller 71. The image signal may include at least first high potential H₁ (for example, 8 V) and first low potential L₁ (for example, 0 V), and may acquire multiple potential therebetween. As a result, pixel potential Vₚₓ is supplied to the pixel electrode 22 of each of the pixels 20 depending on an image to be displayed. Although details will be described later, as an example, the pixel potential Vₚₓ of a pixel 20 which displays a first color (for example, white) is the first low potential L₁ and the pixel potential Vₚₓ of a pixel 20 which displays a second color (for example, black) is the first high potential H₁ in the embodiment.

The common potential supply circuit 74 supplies common potential V_{com} to a common potential line 50, and the common potential line 50 is electrically connected to common electrodes 23. Therefore, the common potential supply circuit 74 supplies the common potential V_{com} to the common electrodes 23. The common potential V_{com} may be alternate potential which has a common potential cycle T_{c}. Further, a fixed potential line 55 is arranged in each of the pixels 20, and the fixed potential line 55 is electrically connected to a second electrode 252 of each storage capacity element 25. Also, although various signals are input into or output from the controller 71, the scan line driving circuit 72, the data line driving circuit 73 and the common potential supply circuit 74, description, which is not particularly related to the embodiment, will be omitted.

As shown in the circuit diagram of FIG. 3B and the sectional view of FIG. 4, each of the pixels 20 includes a pixel switching transistor 21, a pixel electrode 22, a common electrode 23, an electrophoretic material 24, and a storage capacity element 25. The electrophoretic material 24 is arranged between the pixel electrode 22 and the common electrode 23, and capacity is formed by the pixel electrode 22, the common electrode 23, and the electrophoretic material 24. The capacity is referred to as EPD capacity C_{E}. In this manner, an electric field which is generated between the pixel electrode 22 and the common electrode 23 is applied to the electrophoretic material 24.

The pixel switching transistor 21 is configured to include, for example, an N-type transistor. Here, although an upper gate-type thin film transistor is used, a lower gate-type thin film transistor may be used. The pixel switching transistor 21 includes a gate which is electrically connected to the scan line 30, a source which is electrically connected to the data line 40, and a drain which is electrically connected to each one end of the pixel electrode 22 and the storage capacity element 25. The pixel switching transistor 21 outputs the image signal, which is supplied from the data line driving circuit 73 via the data line 40, to the pixel electrode 22 and first electrode 251 at a timing based on the scan signal which is supplied from the scan line driving circuit 72 via the scan line 30 in a pulse-like manner.

The storage capacity element 25 includes a pair of electrodes, that is, the first electrode 251 and the second electrode 252 which are arranged to face each other via a dielectric film. The first electrode 251 is electrically connected to the pixel electrode 22 and the pixel switching transistor 21, and the second electrode 252 is electrically connected to the fixed potential line 55 as described above. Fixed potential V_{F} (for example, 0 V) is supplied to the fixed potential line 55. Although detailed description will be performed later, if storage capacity C_{S} is used as the capacity of the storage capacity element 25, the EPD capacity C_{E} is sufficiently less than the storage capacity C_{S}. As a result, even if the common potential V_{com} is alternate potential, the pixel potential Vₚₓ hardly changes, and thus it is possible to maintain the image signal for only a predetermined period by the storage capacity element 25.

The image signal is supplied to the pixel electrode 22 from the data line driving circuit 73 via the data line 40 and the pixel switching transistor 21. As shown in FIG. 4, the pixel electrode 22 is arranged to face the common electrode 23 with each other via the electrophoretic material 24. The common electrode 23 is electrically connected to the common potential line 50 to which the common potential V_{com} is supplied. The common electrode 23 is provided on a substrate which faces a substrate on which the pixel electrode 22 is formed, and electrophoretic particles are electrophoresed in the vertical direction in the sectional view shown in FIG. 4. Also, a configuration may be made such that the common electrode 23 is provided on a substrate on which the pixel electrode 22 is formed, and the electrophoretic particles are electrophoresed in the horizontal direction (in the longitudinal direction in FIG. 4) in the sectional view shown in FIG. 4.

The electrophoretic material 24 includes first particles which show the first color, and second particles which show the second color. The first particles and the second particles are called electrophoretic particles, and the electrophoretic particles are contained in microcapsules or microcells which are divided by walls while being dispersed by dispersion liquid. At least one side of the first particles and the second particles is charged with positive polarity or negative polarity, and is electrophoresed depending on an electric field which is generated between the pixel electrode 22 and the common electrode 23. In the embodiment, as an example, it is assumed that the first color is a white color, the second color is a black color, and the first particles are charged with negative polarity rather than the second particles. The fact that the first particles are charged with negative polarity rather than the second particles means any one of five cases, that is, a case in which the first particles are strongly charged with negative polarity and the second particles are weakly charged with negative polarity, a case in which the first particles are charged with negative polarity and the second particles are neutral, a case in which the first particles are charged with negative polarity and the second particles are charged with positive polarity, a case in which the first particles are neutral and the second particles are charged with positive polarity, and a case in which the first particles are weakly charged with positive polarity and the second particles are strongly charged with positive polarity.

Further, the strong charge of the electrophoretic particles refers to the faster electrophoresis of the electrophoretic particles in the dispersion liquid under certain electric field intensity. In contrast, the weak charge of the electrophoretic particles refers to the slower electrophoresis of the electrophoretic particles in the dispersion liquid under certain electric field intensity. Therefore, even when the first particles and the second particles have the same polarity, that is, both the first and second particles are positive polarity or negative polarity, the strength of charging is different. Therefore, a difference is generated in electrophoretic speed, and thus it is possible to change the display by changing the dispersion state of the electrophoretic particles. The strength of charging is indicated using an index called, for example, zeta potential or electrophoretic mobility as a detailed numerical value. The zeta potential and the electrophoretic mobility logically have a proportional relationship.

In the embodiment, it is assumed that the first particles of the white color are negatively charged, that the second particles of the black color are positively charged, and that a user views the display from the sides of the common electrodes 23. In this case, as shown in FIG. 4, if the first low potential L₁ (for example, L₁=0 V) is supplied to the pixel electrodes 22, the central potential of the common potential V_{com} which is alternate potential is first middle potential M₁ and the first middle potential M₁ is greater than the first low potential L₁ (for example, M₁=7 V), the second particles of the black color which are positively charged are drawn in the vicinity of the pixel electrodes 22 and the first particles of the white color which are negatively charged are drawn in the vicinity of the common electrodes 23. Therefore, when the electrophoretic display device 150 is viewed from the sides of the common electrodes 23 (from the upper side of FIG. 4), the pixels 20 perform white display. In this manner, it is possible for the electrophoretic display device 150 to display at least the first color and the second color. Also, the first color and the second color are not limited to white and black, and may be the combination of colors (complementary colors) that are in a relationship in which the colors are positioned on the opposite sides in a color circle. For example, a combination of red-colored minute particles and green-colored minute particles, a combination of yellow-colored minute particles and violet-colored minute particles, and a combination of blue-colored minute particles and orange-colored minute particles may be used. In addition, two appropriate colors may be combined based on the three primary colors of the additive mixture of a red color, a green color, and a blue color, or two appropriate colors may be combined based on the three primary colors of the subtractive mixture of cyan, magenta, and yellow. Further, two appropriate colors may be combined based on the six colors. In addition, it is not necessary that the electrophoretic particles are contained in microcapsules. For example, walls are provided and the electrophoretic particles may be received therein.

### Method of Driving Electrophoretic Display Device

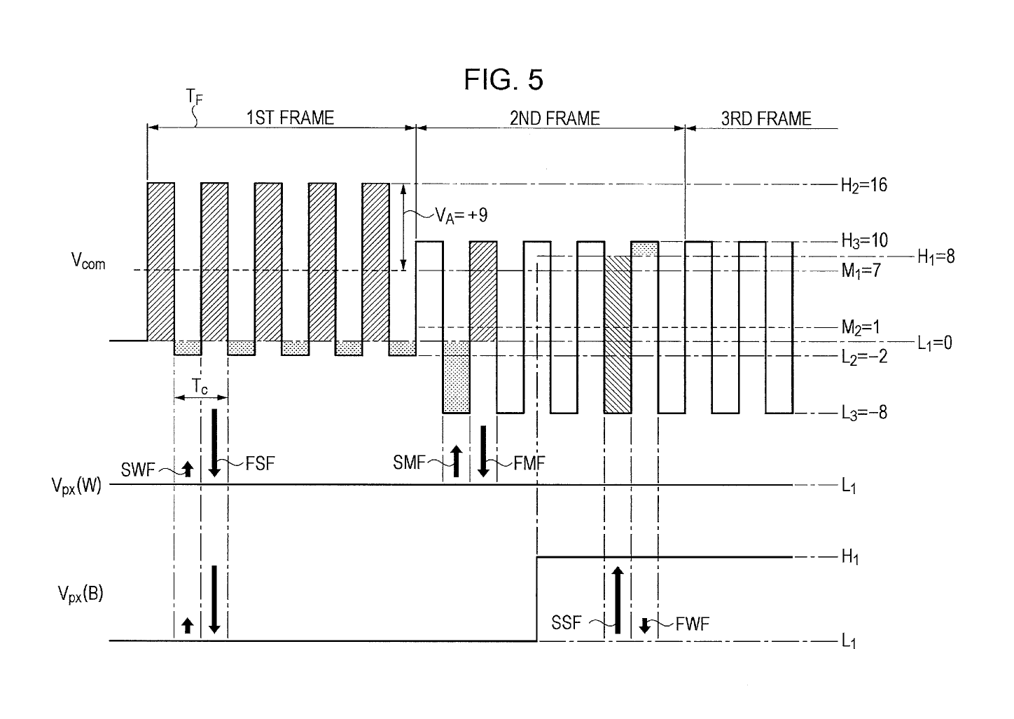

FIG. 5 is a view illustrating an example of a method of driving the electrophoretic display device, the horizontal axis indicates time and the vertical axis indicates potential. Hereinafter, a control circuit and a method of driving the electrophoretic display device according to the embodiment will be described.

In the embodiment, a driving method of setting the whole surface of the display unit 10 to the first color in a first image (first color reset) and subsequently writing pixels which display the second color in a second image that is subsequent to the first image will be described. As an example, a driving method of performing white reset in which the whole surface of the display unit 10 is displayed by white in the first image, and maintaining first color display in first color display pixels (white maintaining pixels) and rewriting the second color in second color display pixels (black rewriting pixels) in the second image will be described. FIG. 5 illustrates the common potential V_{com}, the pixel potential Vₚₓ(W) of the first color display pixels (white maintaining pixels), and the pixel potential Vₚₓ(B) of the second color display pixels (black rewriting pixels). Also, a period in which the first image is formed is a first frame period (first frame), and a cycle in which the second image is formed is a second frame period (second frame). In addition, it is assumed that a first direction is a direction which is faced from the common electrodes 23 to the pixel electrodes 22 (displayed by down arrows in Vₚₓ(W) and Vₚₓ(B) of FIG. 5), and that a second direction which is opposite to the first direction is a direction which is faced from the pixel electrodes 22 to the common electrodes 23 (displayed by up arrows in Vₚₓ(W) and Vₚₓ(B) of FIG. 5). It is assumed that the orientation of an electric field acquired when the electric field faces the first direction is negative, and the orientation of an electric field acquired when the electric field faces the second direction is positive. Further, in FIG. 5, the strength of an electric field is exhibited by the length of an arrow.

When the first color is reset, in order to disperse the first particles on the side of the common electrodes 23 rather than the second particles (cause the first particles to be closer to the common electrodes 23 than the second particles), electric fields which are generated between the pixel electrodes 22 and the common electrodes 23 are alternate electric fields in which a first strong electric field which faces the first direction (hereinafter, the electric field is called a first strong electric field FSF for easy understanding) and a second electric field which is weaker than the first strong electric field FSF (hereinafter, the electric field is called a second weak electric field SWF for easy understanding) are alternately repeated at the common potential cycle T_{c}, as illustrated in Vₚₓ(W) and Vₚₓ(B) in the first frame period (first frame) of FIG. 5. In the same manner, in order to disperse the second particles on the side of the common electrodes 23 rather than the first particles (cause the second particles to be closer to the common electrodes 23 than the first particles) in the black rewriting pixels of the second image, electric fields which are generated between the pixel electrodes 22 and the common electrodes 23 are alternate electric fields in which a third strong electric field which faces the second direction opposite to the first direction (hereinafter, the electric field is called a second strong electric field SSF for easy understanding) and a fourth electric field which is weaker than the second strong electric field SSF (hereinafter, the electric field is called a first weak electric field FWF for easy understanding) are alternately repeated at the common potential cycle T_{c}, as illustrated in Vₚₓ(B) in the second frame period (second frame) of FIG. 5.

The first strong electric field FSF and the second weak electric field SWF or the second strong electric field SSF and the first weak electric field FWF, which configure the alternate electric fields, are formed by supplying alternate potential in which the potential of the second electrode 252 is fixed potential V_{F} (for example, 0 V), the central potential as the common potential V_{com} is first middle potential M₁ or second middle potential M₂, and an amplitude is an amplitude V_{A}. The cycle of the alternate potential is the common potential cycle T_{c}. As will be described later, alternate electric fields are applied to the electrophoretic material 24 in a plurality of times in each frame period, and thus the electrophoretic particles are electrophoresed depending on the average electric field of the alternate electric fields in the order of time which is longer than the frame period. More specifically, the electrophoretic particles are electrophoresed depending on an electric field which is defined by a potential difference between the central potential of the common potential V_{com} and the pixel potential Vₚₓ, and thus it is possible to display the first color and the second color.

The first particles and the second particles are prone to be coupled to each other by Coulomb force or Van der Waals force. However, the first particles are effectively separated from the second particles by applying alternate electric fields to the electrophoretic material 24. According to the earnest study performed by the inventor of the specification, a reason for a low contrast ratio of an electrophoretic display device according to the related art is the insufficient distance between the first particles and the second particles. In contrast, in the embodiment, since the separation of the first particles and the second particles is promoted by the alternate electric fields, an electrophoretic display device is implemented which has a high contrast ratio and which shows excellent image quality. Since the electrophoretic particles are fluctuated in such a way that the electrophoretic particles receive strong force or weak force depending on the alternate electric fields, or the weak force faces a direction which is opposite to that of the strong force depending on a situation, it is considered that the separation of the first particles and the second particles is promoted.

In order to implement the alternate electric fields, it is necessary that the EPD capacity C_{E} is sufficiently less than the storage capacity C_{S}. As shown in FIG. 3B, the EPD capacity C_{E} and the storage capacity C_{S} are connected in series between the fixed potential V_{F} and the common potential V_{com}. It is assumed that the pixel potential is Vₚₓ₁ and the common potential is V_{com1} at time t₁. In addition, it is assumed that the pixel potential is Vₚₓ₂ and the common potential is V_{com2} at time t₂. A relationship expressed in Expression 9 is formed between the potential according to charge conservation.

$${V}_{px 2} - {V}_{px 1} = \frac{{C}_{E}}{{C}_{E} + {C}_{S}} \cdot ( {V}_{com 2} - {V}_{com 1} ) \qquad ( 9 )$$

Therefore, if the EPD capacity C_{E} is sufficiently less than the storage capacity C_{S}, the pixel potential Vₚₓ is hardly move even if the common potential V_{com} is changed. In this manner, if the common potential V_{com} is alternate potential, the electric fields which are generated between the pixel electrodes 22 and the common electrodes 23 are alternate electric fields. More specifically, if the EPD capacity C_{E} is less than a tenth of the storage capacity C_{S} (C_{E}/C_{S}<1/10), it may be said that the EPD capacity C_{E} is sufficiently less than the storage capacity C_{S}. In this case, a change in the pixel potential Vₚₓ is equal to or less than a tenth of a change in the common potential V_{com}, and thus alternate electric fields are implemented. Further, more preferably, if the EPD capacity C_{E} is equal to or less than a hundredth of the storage capacity C_{S} (C_{E}/C_{S}<1/100), it may be said that the EPD capacity C_{E} is sufficiently less than the storage capacity C_{S}. In this case, the change in the pixel potential Vₚₓ is equal to or less than a hundredth of the change in the common potential V_{com}, and thus alternate electric fields are implemented. In the embodiment, the area of the pixel electrode 22 (area which is used by the EPD capacity C_{E}) is at the same level with the area of the storage capacity element 25 (area which is used by the storage capacity C_{S}), the distance between the pixel electrode 22 and the common electrode 23 (cell gap) is at a level of 50 μm, the distance between the first electrode 251 and the second electrode 252 (the thickness of the dielectric film of the storage capacity element 25) is at a level of 0.1 the dielectric constant of the electrophoretic material 24 is at a level of 5, and the dielectric constant of the dielectric film (silicon oxide film) of the storage capacity element 25 is 3.9. Therefore, a ratio of the EPD capacity C_{E} to the storage capacity C_{S} (C_{E}/C_{S}) is small at a level of 1/500. Therefore, in accordance with Expression 9, even if the common potential V_{com} is vibrated with the amplitude V_{A}, the change in the pixel potential Vₚₓ is small at a level of V_{A}/500, and thus alternate electric fields are implemented.

Subsequently, the cycle of an alternate electric field (common potential cycle T_{c}) will be described. As shown in FIG. 5, when it is assumed that a period in which a single frame image is formed is a frame cycle T_{F}, it is preferable that the common potential cycle T_{c} be shorter than the frame cycle T_{F}. The frame cycle T_{F} of the electrophoretic display device 150 is at a level of 30 milliseconds (30 ms) to 1 second (1 s), and the response time of the electrophoretic material 24 is at a level of 10 ms to 500 ms which is shorter than the frame cycle depending on the frame cycle T_{F}. Roughly speaking, it is designed such that approximately ⅕ to 1 time of the frame cycle T_{F} is the response time of the electrophoretic material 24. The response time of the electrophoretic material 24 is time that the electrophoretic particles spend moving between the pixel electrodes 22 and the common electrodes 23 when electric fields are applied to the electrophoretic material 24 at the time of driving.

An object to apply the alternate electric fields to the electrophoretic material 24 is to prompt the separate of the first particles from the second particles. If the first particles and the second particles actually move between the pixel electrodes 22 and the common electrodes 23 due to the alternate electric fields, there is a problem in that screen flicker is generated. In addition, since the user views the first color display and the second color display in a time-division manner, the user feels that the first color is mixed with the second color, and thus the user feels that a contrast ratio deteriorates. Due to such a reason, it is preferable that the common potential cycle T_{c} be a cycle in which the separation of the first particles and the second particles is prompted by the alternate electric fields and in which movement is not possible between the pixel electrodes 22 and the common electrodes 23. On the other hand, if the common potential cycle T_{c} is too short, it is difficult that the first particles are separated from the second particles. Therefore, it is preferable that the common potential cycle T_{c} be included in a range from approximately a tenth of the response time of the electrophoretic material 24 to approximately one time thereof. If so, the first strong electric field FSF is stronger than the second weak electric field SWF and the second strong electric field SSF is stronger than the first weak electric field FWF, and thus the movement distance of the first particles and the second particles is approximately a tenth to one time of the distance between the pixel electrodes 22 and the common electrodes 23 at most, thereby suppressing screen flicker. As described above, the response time of the electrophoretic material 24 is approximately one fifth to one time of the frame cycle T_{F}, and thus it is preferable that the common potential cycle T_{c} be the one fiftieth to one time of the frame cycle T_{F}. In other words, if an alternate electric field is applied to the electrophoretic material 24 approximately one to fifty times for a single frame period T_{F}, flicker is suppressed, and thus an image which has a high contrast ratio and high quality is displayed.

In the embodiment, the size of the display unit 10 is 15.24 cm×11.43 cm, the number of pixels is 2400 (the number n of data lines 40)×1800 (the number m of scan lines 30), and the resolution thereof is 400 dpi. In the data line driving circuit 73, 8-phase expansion driving, in which an image signal is introduced into 8 data lines 40 in response to a single selection signal, is used. A selection time per a single pixel 20 is 1 microsecond (μs) Accordingly, a horizontal scan cycle is 300 microseconds (μs) and the frame cycle T_{F} is 0.54 seconds (s). As shown in FIG. 5, since an alternate electric field is applied to the electrophoretic material 24 five times at a single frame cycle T_{F}, the common potential cycle T_{c} is 108 ms in the embodiment. Also, since the response time of the electrophoretic material 24 is approximately 300 ms, the common potential cycle T_{c} is 0.36 times of the response time of the electrophoretic material 24. As will be described later, since the orientation of the second weak electric field SWF is opposite to the orientation of the first strong electric field FSF and the strength thereof is one eighth of the strength of the first strong electric field FSF, the distance in which the electrophoretic particles move in a direction opposite to a direction to be displayed due to the alternate electric fields is approximately 4.5% of a distance between the pixel electrodes 22 and the common electrodes 23 (=0.36×1/8, 2.25 micrometers (μm) in the embodiment). Accordingly, flicker is not generated and the first particles are effectively separated from the second particles. That is, the electrophoretic display device 150 is implemented which has a high contrast ratio and which displays a high-quality image.

As described above, the integer times of the common potential cycle T_{c} is the frame period T_{F}, an alternate electric field is applied to the electrophoretic material 24 k times (k is an integer which is 1 or greater) for a single frame period T_{F}. Further, it is preferable that the number m of scan lines 30 be the integer times of the double value (2k) of the number of times k of alternate electric fields. In the embodiment, since the number m of scan lines 30 is 1800 and k=5, an alternate electric field is reversed in the positive and negative directions for every 180 scan lines 30. In other words, since the number of times k of alternate electric fields is a value acquired by dividing the frame period T_{F} by the common potential cycle T_{c} (k=T_{F}/T_{c}), it is preferable that the number m of scan lines 30, the frame period T_{F}, and the common potential cycle T_{c} form the relationship expressed in Expression 10.

$$\begin{matrix}m = 2 kI \\ = 2 \times \frac{{T}_{F}}{{T}_{C}} \cdot I\end{matrix} \qquad ( 10 )$$

Here, I is an integer value. Expression 10 means that the number m of scan lines 30 is divided by the double value (2k) of times of the number of times k of alternate electric fields. Therefore, there is not a case in which the common potential V_{com} is replaced with positive or negative for a period during which an arbitrary scan line 30 is selected. That is, if the relationship in Expression 10 is satisfied, timing that the common potential V_{com} is replaced with positive or negative is synchronized with timing that the selection of the scan lines 30 is switched. If the common potential V_{com} is replaced with positive or negative while an image signal is rewritten in the pixels 20, there is a problem in that image display is not correctly performed. That is, there is a problem in that horizontal lines corresponding to the scan lines 30 in which the common potential V_{com} is replaced with positive or negative may be viewed in an image to be displayed. In contrast, if the relationship in Expression 10 is satisfied as described above, the replacement of the common potential V_{com} with positive or negative does not affect the rewriting of the image signal into the pixels 20. Therefore, a problem in that horizontal lines are generated in an image does not occur, the first particles are effectively separated from the second particles, and thus a high-quality image is displayed.

### Potential Relationship

Subsequently, the relationship between the common potential V_{com} and the pixel potential Vₚₓ will be described with reference to FIG. 5. Also, although examples of various types of potential are described with detailed numerical values in FIG. 5 in order to easily understand the description, potential which has another numerical value may be used if potential relationship which will be described below is satisfied.

(1) when First Particles are Charged with Negative Polarity Rather than Second Particles

As described above, a potential relationship when the first particles are charged with negative polarity rather than the second particles will be described in the embodiment.

### (1-0) Setting Parameter

Low potential, which is applied to the pixel electrodes 22 of the pixels 20 which display the first color (white) when the first image is formed (first frame period (first frame)), is called first low potential L₁. In addition, high potential, which is applied to the pixel electrodes 22 of the pixels 20 which display the second color (black) when the second image is formed (second frame period (second frame)), is called first high potential H₁. Further, the central value of the common potential V_{com} acquired when the first image is formed (first frame period (first frame)) is called first middle potential M₁. In the same manner, the central value of the common potential V_{com} acquired when the second image is formed (second frame period (second frame)) is called second middle potential M₂. The absolute value of the amplitude of the common potential V_{com} is called an amplitude V_{A}. Potential, which should be set in order to correctly display an image on the electrophoretic display device 150, includes five different types, that is, the first low potential L₁, the first high potential H₁, the first middle potential M₁, the second middle potential M₂, and the amplitude V_{A}, and these types of potential are called setting parameters. Also, in the embodiment, a fact that the potential V_{H} is higher than the potential V_{L} means that the potential V_{H} is greater than the potential V_{L} in the positive direction. That is, high potential means potential which has a great value in the positive direction and low potential means potential which has a great value in the negative direction.

### (1-1) Definitional Identity

The lowest value of the common potential V_{com} acquired when the first image is formed (first frame period (first frame)) is called second low potential L₂. The second low potential L₂ is expressed in Expression 11.

L₂≡V_{A}+M₁ (11)

The highest value of the common potential V_{com} acquired when the first image is formed (first frame period (first frame)) is called second high potential H₂. The second high potential H₂ is expressed in Expression 12.

H₂≡V_{A}+M₁ (12)

The lowest value of the common potential V_{com} acquired when the second image is formed (second frame period (second frame)) is called third low potential L₃. The third low potential L₃ is expressed in Expression 13.

L₃≡V_{A}+M₂ (13)

The highest value of the common potential V_{com} acquired when the second image is formed (second frame period (second frame)) is called third high potential H₃. The third high potential H₃ is expressed in Expression 14.

H₃≡V_{A}+M₂ (14)

(1-2) White Writing Condition when First Image is Formed (in First Frame Period (First Frame))

First, it is assumed that the distance between the pixel electrodes 22 and the common electrodes 23 is d. When it is assumed that the first strong electric field FSF faces the first direction (downward) and the orientation of the first strong electric field FSF is negative, the first strong electric field FSF is expressed by Expression 15.

$$\begin{matrix}FSF = \frac{{L}_{1} - {H}_{2}}{d} \\ = \frac{{L}_{1} - ( {V}_{A} + {M}_{1} )}{d} < 0\end{matrix} \qquad ( 15 )$$

(1-2-1) when Direction (Upward) of Second Weak Electric Field SWF is Opposite to First Direction (Downward)

If the orientation of the second weak electric field SWF is the second direction, the orientation of the first strong electric field FSF is opposite to the orientation of the second weak electric field SWF, and the first particles are effectively separated from the second particles. Therefore, it is possible to implement the electrophoretic display device 150 which has a high contrast ratio and which displays a high-quality image. In this case, the second weak electric field SWF should be positive, and the second weak electric field SWF is expressed by Expression 16.

$$\begin{matrix}SWF = \frac{{L}_{1} - {L}_{2}}{d} \\ = \frac{{L}_{1} - ( - {V}_{A} + {M}_{1} )}{d} > 0\end{matrix} \qquad ( 16 )$$

Expression 17 is acquired as a relational expression which should be satisfied by the setting parameters based on Expression 15 and Expression 16.

M₁−V_{A}<L₁<M₁+V_{A} (17)

In addition, a condition in which the second weak electric field SWF is weaker than the first strong electric field FSF is expressed in Expression 18.

(M₁+V_{A})−L₁>L₁−(M₁−V_{A}) (18)

Expression 19 is acquired as a relational expression which should be satisfied by the setting parameters based on Expression 18.

L₁<M₁ (19)

Expression 20 is acquired as a relational expression which should be satisfied by the setting parameters based on Expression 17 and Expression 19. Expression 20 is a necessary condition in order to disperse the first particles in the vicinity of the common electrodes (in order to perform white display) when the direction (upward) of the second weak electric field SWF is opposite to the first direction (downward).

0<M₁−L₁<V_{A} (20)

In this manner, it is possible to disperse the first particles which are more strongly charged with negative polarity in the vicinity of the common electrodes 23 or disperse the second particles in the vicinity of the pixel electrodes 22. Accordingly, if the user views the electrophoretic display device 150 from the sides of the common electrodes 23, it is possible to recognize the first color which is shown by the first particles. If the electrophoretic display device 150 is viewed from the sides of the pixel electrodes 22, it is possible to recognize the second color which is shown by the second particles.

(1-2-2) when Direction (Downward) of Second Weak Electric Field SWF is Same as First Direction (Downward)

If the orientation of the second weak electric field SWF is the first direction, the orientation of the first strong electric field FSF is the same as the orientation of the second weak electric field SWF, the average time value of electric fields which are generated between the pixel electrodes 22 and the common electrodes 23 becomes large when the first particles are dispersed in the vicinity of the common electrodes 23. Therefore, even when the electrophoretic display device 150 is driven by a comparatively low voltage, it is possible to implement the electrophoretic display device 150 which has a high contrast ratio and which displays a high-quality image. In this case, the second weak electric field SWF should be negative and is expressed by Expression 21.

$$\begin{matrix}SWF = \frac{{L}_{1} - {L}_{2}}{d} \\ = \frac{{L}_{1} - ( - {V}_{A} + {M}_{1} )}{d} < 0\end{matrix} \qquad ( 17 )$$

Expression 22 is acquired as a relational expression which should be satisfied by the setting parameters based on Expression 15 and Expression 21.

L₁<M₁−V_{A} (22)

In addition, a condition in which the second weak electric field SWF is weaker than the first strong electric field FSF is expressed in Expression 23.

(M₁+V_{A})−L₁>(M₁−V_{A})−L₁ (23)

Expression 24 is acquired as a relational expression which should be satisfied by the setting parameters based on Expression 23.

V_{A}>0 (24)

Since the amplitude V_{A} is always positive based on the definition thereof, Expression 24 is always satisfied automatically. Expression 25 is acquired as a relational expression which should be satisfied by the setting parameters based on Expression 22 and Expression 24. Expression 25 is a necessary condition in order to disperse the first particles in the vicinity of the common electrodes (in order to perform white display) when the direction (downward) of the second weak electric field SWF is the same as the first direction (downward).

0<V_{A}<M₁−L₁ (25)

In this manner, it is possible to disperse the first particles, which are strongly charged with negative polarity, in the vicinity of the common electrodes 23 or disperse the second particles in the vicinity of the pixel electrodes 22. Accordingly, if the user views the electrophoretic display device 150 from the sides of the common electrodes 23, it is possible to recognize the first color which is shown by the first particles. If the user views the electrophoretic display device 150 from the pixel electrodes 22, it is possible to recognize the second color which is shown by the second particles.

(1-3) Black Writing Condition when Second Image is Formed (in Second Frame Period (Second Frame))

A condition in which the second strong electric field SSF faces the second direction (upward) will be considered. The second strong electric field SSF should be positive and is expressed by Expression 26.

$$\begin{matrix}SSF = \frac{{H}_{1} - {L}_{3}}{d} \\ = \frac{{H}_{1} - ( - {V}_{A} + {M}_{2} )}{d} > 0\end{matrix} \qquad ( 26 )$$

(1-3-1) when Direction (Downward) of First Weak Electric Field FWF is Opposite to Second Direction (Upward)

If the orientation of the first weak electric field FWF is the first direction, the orientation of the second strong electric field SSF is opposite to the orientation of the first weak electric field FWF, and the first particles are effectively separated from the second particles. Therefore, it is possible to implement the electrophoretic display device 150 which has a high contrast ratio and displays a high-quality image. In this case, the first weak electric field FWF should be negative and is expressed by Expression 27.

$$\begin{matrix}FWF = \frac{{H}_{1} - {H}_{3}}{d} \\ = \frac{{H}_{1} - ( {V}_{A} + {M}_{2} )}{d} < 0\end{matrix} \qquad ( 27 )$$

Expression 28 is acquired as a relational expression which should be satisfied by the setting parameters based on Expression 26 and Expression 27.

M₂−V_{A}<H₁<M₂V_{A} (28)

In addition, a condition in which the first weak electric field FWF is weaker than the second strong electric field SSF is expressed by Expression 29.

H₁−(M₂−V_{A})>−H₁+(M₂+V_{A}) (29)

Expression 30 is acquired as a relational expression which should be satisfied by the setting parameters based on Expression 29.

M₂<Hₜ (30)

Expression 31 is acquired as a relational expression which should be satisfied by the setting parameters based on Expression 28 and Expression 30. Expression 31 is a necessary condition in order to disperse the second particles in the vicinity of the common electrodes 23 (in order to perform black display when the direction (downward) of the first weak electric field FWF is opposite to the second direction (upward).

0<H₁−M₂<V_{A} (31)

In this manner, it is possible to disperse the first particles, which are more strongly charged with negative polarity, in the vicinity of the pixel electrodes 22 or to disperse the second particles in the vicinity of the common electrodes 23. Accordingly, if the user views the electrophoretic display device 150 from the sides of the common electrodes 23, it is possible to recognize the second color which is shown by the second particles. If the user views the electrophoretic display device 150 from the sides of the pixel electrodes 22, it is possible to recognize the first color which is shown by the first particles.

(1-3-2) when Direction (Upward) of First Weak Electric Field FWF is Same as Second Direction (Upward)

If the orientation of the first weak electric field FWF is the second direction, the orientation of the second strong electric field SSF is the same as the orientation of the first weak electric field FWF, and thus the average time value of the electric fields which are generated between the pixel electrodes 22 and the common electrodes 23 becomes large when the second particles are dispersed in the vicinity of the common electrodes 23. Therefore, even if the electrophoretic display device 150 is driven by a comparatively low voltage, it is possible to implement the electrophoretic display device 150 which has a high contrast ratio and which displays a high-quality image. In this case, the first weak electric field FWF should be positive and is expressed by Expression 32.

$$\begin{matrix}FWF = \frac{{H}_{1} - {H}_{3}}{d} \\ = \frac{{H}_{1} - ( {V}_{A} + {M}_{2} )}{d} > 0\end{matrix} \qquad ( 32 )$$

Expression 33 is acquired as a relational expression which should be satisfied by the setting parameters based on Expression 26 and Expression 32.

M₂+V_{A}<H₁ (33)

In addition, a condition in which the first weak electric field FWF is weaker than the second strong electric field SSF is expressed in Expression 34.

H₁−(M₂−V_{A})>H₁−(M₂+V_{A}) (34)

Expression 35 is acquired as a relational expression which should be satisfied by the setting parameters based on Expression 34.

V_{A}>0 (35)

Expression 36 is acquired as a relational expression which should be satisfied by the setting parameters based on Expression 33 and Expression 35. Expression 36 is a necessary condition in order to disperse the second particles in the vicinity of the common electrodes 23 (in order to perform black display) when the direction (upward) of the first weak electric field FWF is the same as the second direction (upward).

0<V_{A}<H₁−M₂ (36)

In this manner, it is possible to disperse the first particles which are more strongly charged with negative polarity in the vicinity of the pixel electrodes 22 or to disperse the second particles in the vicinity of the common electrodes 23. Accordingly, if the user views the electrophoretic display device 150 from the sides of the common electrodes 23, it is possible to recognize the second color which is shown by the second particles. If the user views the electrophoretic display device 150 from the sides of the pixel electrodes 22, it is possible to recognize the first color which is shown by the first particles.

### (1-4) White-and-Black Symmetry Condition

In order that the white reset is symmetrical to the black writing, it is necessary that the absolute value of the first strong electric field FSF is equal to the absolute value of the second strong electric field SSF, and a condition thereof is expressed in Expression 37.

−L₁+(M₁+V_{A})=H₁−(M₂−V_{A}) (37)

Expression 37 is summarized into Expression 38.

−L₁+M₁=H₁−M₂ (38)

Further, it is preferable that the absolute value of the second weak electric field SWF be equal to the absolute value of the first weak electric field FWF. Therefore, when the direction of the second weak electric field SWF is opposite to the first direction and the direction of the first weak electric field FWF is opposite to the second direction, Expression 39 is acquired based on Expression 16 and Expression 27.

L₁−(M₁−V_{A})−H₁+(M₂+V_{A}) (39)

Since Expression 39 is the same as Expression 38, a white-and-black symmetry condition becomes Expression 38. In the same manner, when the direction of the second weak electric field SWF is the same as the first direction and the direction of the first weak electric field FWF is the same as the second direction, Expression 38 is also acquired based on Expression 21 and Expression 32. If Expression 38 is satisfied, it is possible to symmetrically treat the first color display and the second color display. Therefore, the driving method is not complex, the life span of the electrophoretic material 24 lasts a long time, and thus it is possible to cause the product life span of the electrophoretic display device 150, which performs high quality display with easy driving, to last a long time.

(1-5) Condition of White Maintaining Pixels when Second Image is Formed (Second Frame Period (Second Frame))

In order to maintain white pixels acquired when the second image is formed (second frame period (second frame)), a fifth electric field (hereinafter, the electric field is called a first middle electric field FMF for easy understanding) should face the first direction (downward) and should be negative, and is expressed by Expression 40.

$$\begin{matrix}FMF = \frac{{L}_{1} - {H}_{3}}{d} \\ = \frac{{L}_{1} - ( {V}_{A} + {M}_{2} )}{d} < 0\end{matrix} \qquad ( 40 )$$

(1-5-1) when Direction (Upward) of Second Middle Electric Field SMF is Opposite to First Direction (Downward)

In this case, a sixth electric field (hereinafter, the electric field is called a second middle electric field SMF for easy understanding) should be positive and is expressed by Expression 41.

$$\begin{matrix}SMF = \frac{{L}_{1} - {L}_{3}}{d} \\ = \frac{{L}_{1} - ( - {V}_{A} + {M}_{2} )}{d} > 0\end{matrix} \qquad ( 41 )$$

Expression 42 is acquired as a relational expression which should be satisfied by the setting parameters based on Expression 40 and Expression 41.

M₂−V_{A}<L₁<M₂+V_{A} (42)

In addition, a condition in which the second middle electric field SMF is weaker than the first middle electric field FMF is expressed as Expression 43.

(M₂+V_{A})−L₁>L₁−(M₂−V_{A}) (43)

Expression 44 is acquired as a relational expression which should be satisfied by the setting parameters based on Expression 43.

L₁<M₂ (44)

Expression 45 is acquired as a relational expression which should be satisfied by the setting parameters based on Expression 42 and Expression 44. Expression 45 is a condition in order to maintain the first particles in the vicinity of the common electrodes 23 (in order to maintain the white display) when the direction (upward) of the second middle electric field SMF is opposite to the first direction (downward) in the second frame period (second frame).

0<M₂−L₁<V_{A} (45)

In this manner, it is possible to maintain the first particles which are more strongly charged with negative polarity in the vicinity of the common electrodes 23 and to maintain the second particles in the vicinity of the pixel electrodes 22. Accordingly, even in the second frame period (second frame), in the pixels 20 which display the first color, it is possible to recognize the first color which is shown by the first particles if the user views the electrophoretic display device 150 from the sides of the common electrodes 23, and it is possible to recognize the second color which is shown by the second particles if the user views the electrophoretic display device 150 from the sides of the pixel electrodes 22.

(1-5-2) when Direction (Downward) of Second Middle Electric Field SMF is Same as First Direction (Downward)

In this case, the second middle electric field SMF should be negative and is expressed by Expression 46.

$$\begin{matrix}SMF = \frac{{L}_{1} - {L}_{3}}{d} \\ = \frac{{L}_{1} - ( - {V}_{A} + {M}_{2} )}{d} < 0\end{matrix} \qquad ( 46 )$$

Expression 47 is acquired as a relational expression which should be satisfied by the setting parameters based on Expression 40 and Expression 46.

L₁<M₂−V_{A} (47)

In addition, a condition in which the second middle electric field SMF is weaker than the first middle electric field FMF is expressed as Expression 48.

(M₂+V_{A})−L₁>(M₂−V_{A})−L₁ (48)

Expression 49 is acquired as a relational expression which should be satisfied by the setting parameters based on Expression 48.

V_{A}>0 (49)

Expression 50 is acquired as a relational expression which should be satisfied by the setting parameters based on Expression 47 and Expression 49. Expression 50 is a condition in order to maintain the first particles in the vicinity of the common electrodes 23 (in order to maintain the white display) when the direction (downward) of the second middle electric field SMF is the same as the first direction (downward) in the second frame period (second frame).

0<V_{A}<M₂−L₁ (50)

In this manner, it is possible to maintain the first particles which are more strongly charged with negative polarity in the vicinity of the common electrodes 23 and maintain the second particles in the vicinity of the pixel electrodes 22. Accordingly, even in the second frame period (second frame), in the pixels 20 which display the first color, if the user views the electrophoretic display device 150 from the sides of the common electrodes 23, it is possible to recognize the first color which is shown by the first particles. If the user views the electrophoretic display device 150 from the sides of the pixel electrodes 22, it is possible to recognize the second color which is shown by the second particles.

### (1-6) Conclusion

Finally, when the first direction (downward) is opposite to the direction of the second weak electric field SWF (upward), Expression 20 which is the white reset condition and Expression 31 which is the black reset condition are essential conditions in order to perform display. In addition, Expression 38 which is the white-and-black symmetry condition is a condition which is preferable to be satisfied in order to implement high durability based on the potential symmetry. Further, Expression 45 which is the white maintaining pixel condition in the second frame period (second frame) is a condition which is preferable to be satisfied in order to perform white display with high reflectance. As shown in FIG. 5, as an example, if L₁=0 V, H₁=8 V, M₁=7 V, M₂=1 V, and V_{A}=9 V, based on Expression 11 to Expression 14, L₂=−2 V, H₂=16 V, L₃=−8 V, H₃=10 V, then Expression 20, Expression 31, Expression 38 and Expression 45 are satisfied.

On the other hand, when the first direction (downward) is the same as the direction of the second weak electric field SWF (downward), Expression 25 which is the white reset condition and Expression 36 which is the black writing condition are essential conditions in order to perform display. In addition, Expression 38 which is the white-and-black symmetry condition is a condition which is preferable to be satisfied in order to implement high durability based on the potential symmetry. When the first direction (downward) is the same as the direction of the second weak electric field SWF (downward) and the first direction (downward) is opposite to the direction (upward) of the second middle electric field SMF, Expression 45 which is the white maintaining pixel condition in the second frame period (second frame) is a condition which is preferable to be satisfied in order to perform white display with high reflectance. As an example, if it is assumed that L₁=0 V, H₁=8 V, M₁=7 V, M₂=1 V and V_{A}=5 V based on Expression 11 to Expression 14, L₂=2 V, H₂=12 V, L₃=−4 V, and H₃=6 V, then Expression 25, Expression 36, Expression 38, and Expression 45 are satisfied. When the first direction (downward) is the same as the direction of the second weak electric field SWF (downward) and the first direction (downward) is the same as the direction (downward) of the second middle electric field SMF, Expression 50 which is the white maintaining pixel in the second frame period (second frame) is a condition which is preferable to be satisfied in order to perform white display with high reflectance. As an example, if it is assumed that L₁=0 V, H₁=8 V, M₁=7 V, M₂=1 V, and V_{A}=0.5 V, based on Expression 11 to Expression 14, L₂=6.5 V, H₂=7.5 V, L₃=0.5 V, and H₃=1.5 V, then Expression 25, Expression 36, Expression 38, and Expression 50 are satisfied.

Also, an average electric field E₁, which is applied to pixel electrodes 22 on the basis of the common electrodes 23 acquired when the first image is formed (first frame period (first frame)), is Expression 51.

$$\begin{matrix}{E}_{1} = \frac{( {V}_{px} ( 1 ) - {V}_{com} )}{d} \\ = \frac{( {L}_{1} - {M}_{1} )}{d} \\ = - \frac{{M}_{1} - {L}_{1}}{d}\end{matrix} \qquad ( 51 )$$

In addition, the average electric field E_{2W}, which is applied to pixel electrodes 22 on the basis of the common electrodes 23 in the white maintaining pixels acquired when the second image is formed (second frame period (second frame)), is Expression 52.

$$\begin{matrix}{E}_{2 W} = \frac{( {V}_{px} ( 2 W ) - {V}_{com} )}{d} \\ = \frac{( {L}_{1} - {M}_{2} )}{d} \\ = - \frac{{M}_{2} - {L}_{1}}{d}\end{matrix} \qquad ( 52 )$$

Further, the average electric field E_{2B}, which is applied to pixel electrodes 22 on the basis of the common electrodes 23 in the black pixels acquired when the second image is formed (second frame period (second frame)), is Expression 53.

$$\begin{matrix}{E}_{2 B} = \frac{( {V}_{px} ( 2 B ) - {V}_{com} )}{d} \\ = \frac{{H}_{1} - {M}_{2}}{d} \\ = - \frac{{M}_{1} - {L}_{1}}{d}\end{matrix} \qquad ( 53 )$$

### Electronic Apparatus

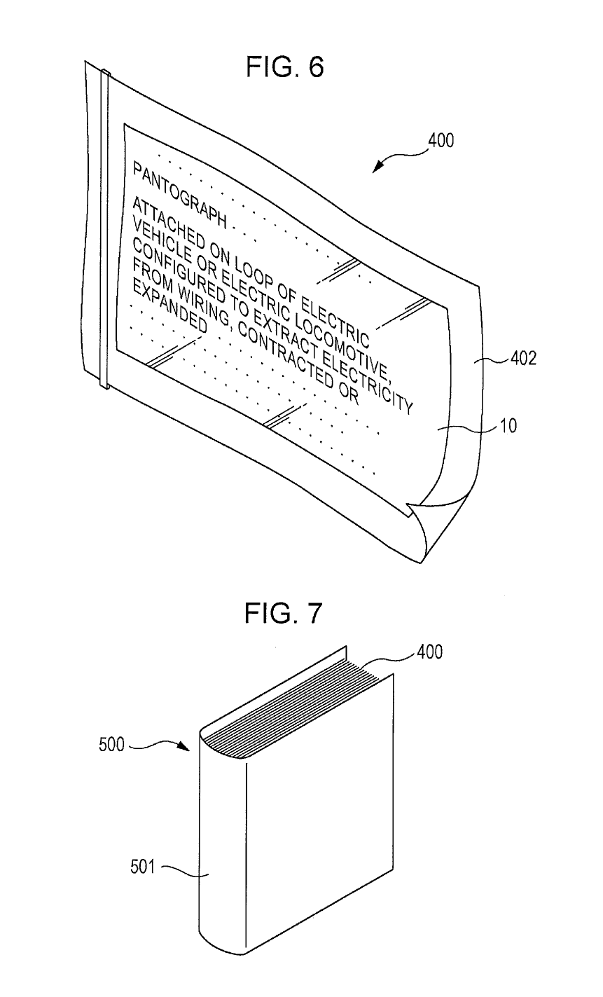

Subsequently, an electronic apparatus to which the above-described electrophoretic display device is applied will be described with reference to FIGS. 6 and 7. Hereinafter, cases in which the above-described electrophoretic display device is applied to an electronic paper and an electronic note will be used as examples.

FIG. 6 is a perspective view illustrating the configuration of an electronic paper. As shown in FIG. 6, an electronic paper 400 includes the electrophoretic display device according to the embodiment as a display unit 10. The electronic paper 400 has flexibility, and is configured to include a main body 402 which is formed of a rewritable sheet having texture and flexibility that are the same as those of the related art.

FIG. 7 is a perspective view illustrating the configuration of the electronic note. As shown in FIG. 7, an electronic note 500 is configured in such a way that the plurality of pieces of electronic paper 400 shown in FIG. 6 are bundled and interposed to a cover 501. The cover 501 includes, for example, a display data input unit (image signal supply circuit 130) in order to input display data which is transmitted from an external device. Therefore, it is possible to change or update displayed content according to the display data while the pieces of electronic paper are interposed.

Each of the above-described electronic paper 400 and the electronic note 500 includes the electrophoretic display device according to the embodiment, and thus it is possible to perform high-quality image display. Also, in addition thereto, it is possible to apply the electrophoretic display device according to the embodiment to the display unit of an electronic apparatus, such as a watch, a mobile phone, or a portable audio device.

As described above, according to the electronic apparatus 100 (driving method) according to the embodiment, it is possible to acquire the following effects.

According to the driving method according to the embodiment, it is possible to display a high-quality image which has a high contrast ratio and in which flicker is not generated, and it is possible to extend the product life span of the electronic apparatus 100. In addition, it is possible to provide the control circuit 140, the electrophoretic display device 150, and the electronic apparatus which can acquire a high-quality image and a long product life span.

Also, in the embodiment, the electrophoretic material 24, which includes electrophoretic particles dispersed in liquid, is used as an example of the electrophoretic display device 150. However, it is possible to apply the embodiment to the electrophoretic display device 150 which uses an electrophoretic material other than the electrophoretic material 24. That is, it is possible to adopt the embodiment to the whole electrophoretic display device 150 which changes the dispersion state of the electrophoretic particles which are charged by applying a voltage between the pixel electrodes 22 and electrodes which are opposite thereto. In detail, it is possible to adopt the embodiment to an electric granular display device which causes charged fine powder to move in a vapor phase.

### Second Embodiment

### Form in which First Particles are Strongly Positively Charged

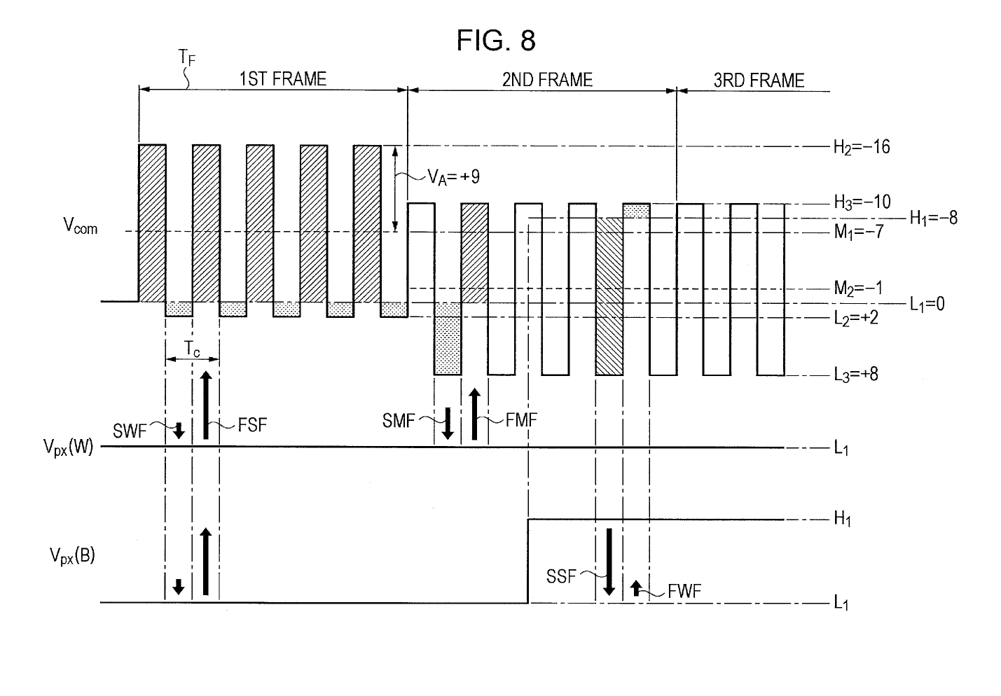

FIG. 8 is a view illustrating a method of driving an electrophoretic display device according to a second embodiment. Hereinafter, the method of driving an electrophoretic display device according to the embodiment will be described. Also, the same reference numerals designate the same components in the first embodiment, and the description thereof will not be repeated.

(2) when First Particles are Charged with Positive Polarity Rather than Second Particles

When the embodiment (FIG. 8) is compared with the first embodiment (FIG. 5), the electrophoretic particles are charged differently. The other configurations are almost the same as those of the first embodiment. In the first embodiment, the first particles are charged with the negative polarity rather than the second particles. However, in the embodiment, the first particles are charged with positive polarity rather than the second particles. The potential relationship in this case will be described. The case in which the first particles are charged with positive polarity rather than the second particles means at least one of five cases, that is, a case in which the first particles are strongly charged with positive polarity and the second particles are weakly charged with positive polarity, a case in which the first particles are charged with positive polarity and the second particles are neutral polarity, a case in which the first particles are charged with positive polarity and the second particles are charged with negative polarity, a case in which the first particles are neutral polarity and the second particles are charged with negative polarity, and a case in which the first particles are weakly charged with negative polarity and the second particles are strongly charged with negative polarity. In the embodiment, it is assumed that the first particles of a white color are positively charged, that the second particles of a black color are negatively charged, and that a user views the display from the sides of the common electrodes 23. The other configurations are the same as those in the first embodiment.

### (2-0) Setting Parameters

Low potential, which is applied to the pixel electrodes 22 of the pixels 20 which display the first color (white) when the first image is formed (first frame period (first frame)), is called first low potential L₁. In addition, high potential, which is applied to the pixel electrodes 22 of the pixels 20 which display the second color (black) when the second image is formed (second frame period (second frame)), is called first high potential H₁. Further, the central value of common potential V_{com} acquired when the first image is formed (first frame period (first frame)) is called a first middle potential M₁. In the same manner, the central value of common potential V_{com} acquired when the second image is formed (second frame period (second frame)) is called second middle potential M₂. The absolute value of the amplitude of the common potential V_{com} is called correctly display an image on the electrophoretic display device 150 includes five kinds of potential, that is, the first low potential L₁, the first high potential H₁, the first middle potential M₁, the second middle potential M₂, and the amplitude V_{A}, the five kinds of potential are called setting parameters. Also, in the embodiment, a fact that potential called V_{H} is higher than the potential called V_{L} means that V_{H} is greater than V_{L} in the negative direction. That is, high potential means potential which has a large value in the negative direction, low potential means potential which has a large value in the positive direction. In addition, it is assumed that the first direction is a direction which is faced from the pixel electrodes 22 to the common electrodes 23 (displayed by up-side arrows in Vₚₓ(W) and Vₚₓ(B) of FIG. 8), and that the second direction which is opposite to the first direction is a direction which is faced from the common electrodes 23 to the pixel electrodes (displayed by down-side arrows in Vₚₓ(W) and Vₚₓ(B) of FIG. 8).

### (2-1) Definitional Expression

When the first image is formed (first frame period (first frame)), the lowest value of the common potential V_{com} is called second low potential L₂. The second low potential L₂ is expressed in Expression 54.

L₂≡V_{A}+M₁ (54)

When the first image is formed (first frame period (first frame)), the highest value of the common potential V_{com} is called second high potential H₂. The second high potential H₂ is expressed in Expression 55.

H₂≡−V_{A}+M₁ (55)

When the second image is formed (second frame period (second frame)), the lowest value of the common potential V_{com} is called third low potential L₃. The third low potential L₃ is expressed in Expression 56.

L₃≡V_{A}+M₂ (56)

When the second image is formed (second frame period (second frame)), the highest value of the common potential V_{com} is called third high potential H₃. The third high potential H₃ is expressed in Expression 57.

H₃≡V_{A}+M₂ (57)

(2-2) White Writing Condition when First Image is Formed (First Frame Period (First Frame))

First, it is assumed that a distance between the pixel electrodes 22 and the common electrodes 23 is d. If the first strong electric field FSF faces the first direction (upward) and the orientation of the first strong electric field FSF is positive, the first strong electric field FSF is expressed by Expression 58.

$$\begin{matrix}FSF = \frac{{L}_{1} - {H}_{2}}{d} \\ = \frac{{L}_{1} - ( - {V}_{A} + {M}_{1} )}{d} > 0\end{matrix} \qquad ( 58 )$$

(2-2-1) when Direction of Second Weak Electric Field SWF (Downward) is Opposite to First Direction (Upward)

If the orientation of the second weak electric field SWF is the second direction, the orientation of the first strong electric field FSF is opposite to the orientation of the second weak electric field SWF and the first particles are effectively separated from the second particles, and thus it is possible to implement the electrophoretic display device 150 which has a high contrast ratio and which displays a high-quality image. In this case, the second weak electric field SWF should be negative and is expressed by Expression 59.

$$\begin{matrix}SWF = \frac{{L}_{1} - {L}_{2}}{d} \\ = \frac{{L}_{1} - ( {V}_{A} + {M}_{1} )}{d} < 0\end{matrix} \qquad ( 59 )$$

Expression 60 is acquired as a relational expression which should be satisfied by the setting parameters based on Expression 58 and Expression 59.

M₁−V_{A}<L₁<M₁+V_{A} (60)

In addition, a condition in which the second weak electric field SWF is weaker than the first strong electric field FSF is expressed as Expression 61.

L₁−(M₁−V_{A})>−L₁+(M₁+V_{A}) (61)

Expression 62 is acquired as a relational expression which should be satisfied by the setting parameters based on Expression 61.

L₁>M₁ (62)

Expression 63 is acquired as a relational expression which should be satisfied by the setting parameters based on Expression 60 and Expression 62. Expression 63 is a necessary condition in order to disperse first particles in the vicinity of the common electrodes 23 (in order to perform white display) when the direction of the second weak electric field SWF (downward) is opposite to the first direction (upward).

0<L₁−M₁<V_{A} (63)

In this manner, it is possible to disperse the first particles which are more strongly charged with positive polarity in the vicinity of the common electrodes 23 or it is possible to disperse the second particles in the vicinity of the pixel electrodes 22. Accordingly, if the user views the electrophoretic display device 150 from the sides of the common electrodes 23, it is possible to recognize the first color which is shown by the first particles. If the user views the electrophoretic display device 150 from the sides of the pixel electrodes 22, it is possible to recognize the second color which is shown by the second particles.

(2-2-2) when Direction of Second Weak Electric Field SWF (Upward) is Same as First Direction (Upward)

If the orientation of the second weak electric field SWF is the first direction, the orientation of the first strong electric field FSF is the same as the orientation of the second weak electric field SWF, and thus the average time value of the electric fields, which are generated between the pixel electrodes 22 and the common electrodes 23, becomes large when the first particles are dispersed in the vicinity of the common electrodes 23. Therefore, even if the electrophoretic display device 150 is driven by a comparatively low voltage, it is possible to implement the electrophoretic display device 150 which has a high contrast ratio and which displays a high-quality image. In this case, the second weak electric field SWF should be positive and is expressed by Expression 64.

$$\begin{matrix}SWF = \frac{{L}_{1} - {L}_{2}}{d} \\ = \frac{{L}_{1} - ( {V}_{A} + {M}_{1} )}{d} > 0\end{matrix} \qquad ( 64 )$$

Expression 65 is acquired as a relational expression which should be satisfied by the setting parameters based on Expression 58 and Expression 64.

L₁>M₁+V₄ (65)

In addition, a condition in which the second weak electric field SWF is weaker than the first strong electric field FSF is expressed as Expression 66.

L₁−(M₁−V_{A})>L₁−(M₁+V_{A}) (66)

Expression 67 is acquired as a relational expression which should be satisfied by the setting parameters based on Expression 66.

V_{A}>0 (67)

Since the amplitude V_{A} is always positive based on the definition thereof, Expression 67 is always satisfied automatically. Expression 68 is acquired as a relational expression which should be satisfied by the setting parameters based on Expression 65 and Expression 67. Expression 68 is a necessary condition in order to disperse the first particles in the vicinity of the common electrodes 23 (in order to perform white display) when the direction of the second weak electric field SWF (upward) is the same as the first direction (upward).

0<V_{A}<L₁−M₁ (68)

In this manner, it is possible to disperse the first particles which are more strongly charged with positive polarity in the vicinity of the common electrodes 23 or it is possible to disperse the second particles in the vicinity of the pixel electrodes 22. Accordingly, if the user views the electrophoretic display device 150 from the sides of the common electrodes 23, it is possible to recognize the first color which is shown by the first particles. If the user views the electrophoretic display device 150 from the sides of the pixel electrodes 22, it is possible to recognize the second color which is shown by the second particles.

(2-3) Black Writing Condition when Second Image is Formed (Second Frame Period (Second Frame))

The condition in which the second strong electric field SSF faces the second direction (downward) is considered. The second strong electric field SSF should be negative and is expressed by Expression 69.

$$\begin{matrix}SSF = \frac{{H}_{1} - {L}_{3}}{d} \\ = \frac{{H}_{1} - ( {V}_{A} + {M}_{2} )}{d} < 0\end{matrix} \qquad ( 69 )$$

(2-3-1) when Direction of First Weak Electric Field FWF (Upward) is Opposite to Second Direction (Downward)

If the orientation of the first weak electric field FWF is the first direction, the orientation of the second strong electric field SSF is opposite to the orientation of the first weak electric field FWF and the first particles are effectively separated from the second particles, and thus it is possible to implement the electrophoretic display device 150 which has a high contrast ratio and which displays a high-quality image. In this case, the first weak electric field FWF should be positive and is expressed by Expression 70.

$$\begin{matrix}FWF = \frac{{H}_{1} - {H}_{3}}{d} \\ = \frac{{H}_{1} - ( - {V}_{A} + {M}_{2} )}{d} > 0\end{matrix} \qquad ( 70 )$$

Expression 71 is acquired as a relational expression which should be satisfied by the setting parameters based on Expression 69 and Expression 70.

M₂−V_{A}<H₁<M₂+V_{A} (71)

In addition, a condition in which the first weak electric field FWF is weaker than the second strong electric field SSF is expressed as Expression 72.

−H₁+(M₂+V_{A})>H₁−(M₂−V_{A}) (72)

Expression 73 is acquired as a relational expression which should be satisfied by the setting parameters based on Expression 72.

M₂>H₁ (73)

Expression 74 is acquired as a relational expression which should be satisfied by the setting parameters based on Expression 71 and Expression 73. Expression 74 is a necessary condition in order to disperse the second particles in the vicinity of the common electrodes 23 (in order to perform black display) when the direction of the first weak electric field FWF (upward) is opposite to the second direction (downward).

0<H₁+M₂<V_{A} (74)

In this manner, it is possible to disperse the first particles which are more strongly charged with positive polarity in the vicinity of the pixel electrodes 22 or it is possible to disperse the second particles in the vicinity of the common electrodes 23. Accordingly, if the user views the electrophoretic display device 150 from the sides of the common electrodes 23, it is possible to recognize the second color which is shown by the second particles. If the user views the electrophoretic display device 150 from the sides of the pixel electrodes 22, it is possible to recognize the first color which is shown by the first particles.

(2-3-2) when Direction of First Weak Electric Field FWF (Downward) is Same as Second Direction (Downward)

If the orientation of the first weak electric field FWF is the second direction, the orientation of the second strong electric field SSF is the same as the orientation of the first weak electric field FWF, and thus the average time value of the electric fields which are generated between the pixel electrodes 22 and the common electrodes 23 becomes large when the second particles are dispersed in the vicinity of the common electrodes 23. Therefore, even if the electrophoretic display device 150 is driven by a comparatively low voltage, it is possible to implement the electrophoretic display device 150 which has a high contrast ratio and which displays a high-quality image. In this case, the first weak electric field FWF should be negative and is expressed by Expression 75.

$$\begin{matrix}FWF = \frac{{H}_{1} - {H}_{3}}{d} \\ = \frac{{H}_{1} - ( - {V}_{A} + {M}_{2} )}{d} < 0\end{matrix} \qquad ( 75 )$$

Expression 76 is acquired as a relational expression which should be satisfied by the setting parameters based on Expression 69 and Expression 75.

M₂−V_{A}>H₁ (76)

In addition, a condition in which the first weak electric field FWF is weaker than the second strong electric field SSF is expressed as Expression 77.

H₁−(M₂−V_{A})>H₁−(M₂+V_{A}) (77)

Expression 78 is acquired as a relational expression which should be satisfied by the setting parameters based on Expression 77.

V_{A}>0 (78)

Expression 79 is acquired as a relational expression which should be satisfied by the setting parameters based on Expression 76 and Expression 78. Expression 79 is a necessary condition in order to disperse the second particles in the vicinity of the common electrodes 23 (in order to perform black display) when the direction of the first weak electric field FWF (downward) is the same as the second direction (downward).

0<V_{A}<M₂−H₁ (79)

In this manner, it is possible to disperse the first particles which are more strongly charged with positive polarity in the vicinity of the pixel electrodes 22 or it is possible to disperse the second particles in the vicinity of the common electrodes 23. Accordingly, if the user views the electrophoretic display device 150 from the sides of the common electrodes 23, it is possible to recognize the second color which is shown by the second particles. If the user views the electrophoretic display device 150 from the sides of the pixel electrodes 22, it is possible to recognize the first color which is shown by the first particles.

### (2-4) White-and-Black Symmetry Condition

In order that the white reset is symmetrical to the black writing, it is necessary that the absolute value of the first strong electric field FSF is equal to the absolute value of the second strong electric field SSF, and is expressed as Expression 80.

L₁−(M₁−V_{A})=−H₁+(M₂+V_{A}) (80)

Expression 80 is summarized to Expression 81.

−L₁+M₁=H₁−M₂ (81)

Further, it is preferable that the absolute value of the second weak electric field SWF be equal to the absolute value of the first weak electric field FWF. Therefore, when the direction of the second weak electric field SWF is opposite to the first direction and the direction of the first weak electric field FWF is the same as the first direction, Expression 82 is acquired based on Expression 59 and Expression 70.

−L₁+(M₁+V_{A})=H₁−(M₂−V_{A}) (82)

Since Expression 82 is the same as Expression 81, the white-and-black symmetry condition becomes Expression 81. In the same manner, when the direction of the second weak electric field SWF is the same as the first direction and the direction of the first weak electric field FWF is the same as the second direction, Expression 81 is also acquired based on Expression 64 and Expression 75. If Expression 82 is satisfied, it is possible to symmetrically treat the first color display and the second color display. Therefore, the driving method is not complex, the life span of the electrophoretic material 24 lasts a long time, and thus it is possible to cause the product life span of the electrophoretic display device 150, which performs high quality display, to last a long time with easy driving.

(2-5) White Maintaining Pixel Condition when Second Image is Formed (Second Frame Period (Second Frame))

In order to maintain the white pixels acquired when the second image is formed (second frame period (second frame)), the first middle electric field FMF should face the first direction (upward) and should be positive. The first middle electric field FMF is expressed by Expression 83.

$$\begin{matrix}FMF = \frac{{L}_{1} - {H}_{3}}{d} \\ = \frac{{L}_{1} - ( - {V}_{A} + {M}_{2} )}{d} > 0\end{matrix} \qquad ( 83 )$$

(2-5-1) when Direction (Downward) of Second Middle Electric Field SMF is Opposite to First Direction (Upward)

In this case, the second middle electric field SMF should be negative, and is expressed by Expression 84.

$$\begin{matrix}SMF = \frac{{L}_{1} - {L}_{3}}{d} \\ = \frac{{L}_{1} - ( {V}_{A} + {M}_{2} )}{d} < 0\end{matrix} \qquad ( 84 )$$

Expression 85 is acquired as a relational expression which should be satisfied by the setting parameters based on Expression 83 and Expression 84.

M₂−V_{A}<L₁<M₂+V_{A} (85)

In addition, a condition in which the second middle electric field SMF is weaker than the first middle electric field FMF is expressed as Expression 86.

(M₂+V_{A})−L₁<L₁−(M₂−V_{A}) (86)

Expression 87 is acquired as a relational expression which should be satisfied by the setting parameters based on Expression 86.

L₁>M₂ (87)

Expression 88 is acquired as a relational expression which should be satisfied by the setting parameters based on Expression 85 and Expression 87. Expression 88 is a condition in order to maintain the first particles in the vicinity of the common electrodes 23 (in order to maintain the white display) when the direction (downward) of the second middle electric field SMF is opposite to the first direction (upward) in the second frame period (second frame).

0<−M₂+L₁<V_{A} (88)

In this manner, it is possible to maintain the first particles which are more strongly charged with positive polarity in the vicinity of the common electrodes 23 and it is possible to maintain the second particles in the vicinity of the pixel electrodes 22. Accordingly, even in the second frame period (second frame), in the pixels 20 which display the first color, if the user views the electrophoretic display device 150 from the sides of the common electrodes 23, it is possible to recognize the first color which is shown by the first particles. If the user views the electrophoretic display device 150 from the sides of the pixel electrodes 22, it is possible to recognize the second color which is shown by the second particles.

(2-5-2) when Direction (Upward) of Second Middle Electric Field SMF is Same as First Direction (Upward)

In this case, the second middle electric field SMF should be positive and is expressed by Expression 89.

$$\begin{matrix}SMF = \frac{{L}_{1} - {L}_{3}}{d} \\ = \frac{{L}_{1} - ( {V}_{A} + {M}_{2} )}{d} > 0\end{matrix} \qquad ( 89 )$$

Expression 90 is acquired as a relational expression which should be satisfied by the setting parameters based on Expression 83 and Expression 89.

L₁>M₂+V_{A} (90)

In addition, a condition in which the second middle electric field SMF is weaker than the first middle electric field FMF is expressed as Expression 91.

(M₂+V_{A})−L₁>(M₂−V_{A})−L₁ (91)

Expression 92 is acquired as a relational expression which should be satisfied by the setting parameters based on Expression 91.

V_{A}>0 (92)

Expression 93 is acquired as a relational expression which should be satisfied by the setting parameters based on Expression 90 and Expression 92. Expression 93 is a condition in order to maintain the first particles in the vicinity of the common electrodes 23 (in order to maintain the white display) when the direction (upward) of the second middle electric field SMF is the same as the first direction (upward) in the second frame period (second frame).

0<V_{A}<L₁−M₂ (93)

In this manner, it is possible to maintain the first particles which are more strongly charged with positive polarity in the vicinity of the common electrodes 23 and it is possible to maintain the second particles in the vicinity of the pixel electrodes 22. Accordingly, even in the second frame period (second frame), in the pixels 20 which display the first color, if the user views the electrophoretic display device 150 from the sides of the common electrodes 23, it is possible to recognize the first color which is shown by the first particles. If the user views the electrophoretic display device 150 from the sides of the pixel electrodes 22, it is possible to recognize the second color which is shown by the second particles.

### (2-6) Conclusion

Finally, when the first direction (upward) is opposite to the direction of the second weak electric field SWF (downward), Expression 63 which is the white reset condition and Expression 74 which is the black writing condition are essential conditions in order to perform display. In addition, Expression 81 which is the white-and-black symmetry condition is a condition which is preferable to be satisfied in order to implement high durability based on potential symmetry. Further, Expression 88 which is the white maintaining pixel condition in the second frame period (second frame) is a condition which is preferable to be satisfied in order to perform white display with high reflectance. As shown in FIG. 8, as an example, if L₁=0 V, H₁=−8 V, M₁=−7 V, M₂=−1 V and V_{A}=9 V, L₂=+2 V, H₂=−16 V, L₃=+8 V and H₃=−10 V based on Expression 54 to Expression 57, then Expression 63, Expression 74, Expression 81, and Expression 88 are satisfied.

On the other hand, when the first direction (upward) is the same as the direction of the second weak electric field SWF (upward), Expression 68 which is the white reset condition and Expression 79 which is the black writing condition are essential conditions in order to perform display. In addition, Expression 81 which is the white-and-black symmetry condition is a condition which is preferable to be satisfied in order to implement high durability based on potential symmetry. When the first direction (upward) is the same as the direction of the second weak electric field SWF (upward) and the first direction (upward) is opposite to the direction (downward) of the second middle electric field SMF, Expression 88 which is the white maintaining pixel condition in the second frame period (second frame) is a condition which is preferable to be satisfied in order to perform white display with high reflectance. As an example, if L₁=0 V, H₁=−8 V, M₁=−7 V, M₂=−1 V and V_{A}=5 V, based on Expression 54 to Expression 57, L₂=−2 V, H₂=−12 V, L₃=+4 V, H₃=−6 V, then Expression 68, Expression 79, Expression 81, and Expression 88 are satisfied. When the first direction (upward) is the same as the direction of the second weak electric field SWF (upward) and the first direction (upward) is also the same as the direction (upward) of the second middle electric field SMF, Expression 93 which is the white maintaining pixel condition in the second frame period (second frame) is a condition which is preferable to be satisfied in order to perform white display with high reflectance. As an example, if L₁=0 V, H₁=−8 V, M₁=−7 V, M₂=−1 V and V_{A}=0.5 V, L₂=−6.5 V, H₂=−7.5 V, L₃=−0.5 V and H₃=−1.5 V based on Expression 54 to Expression 57, then Expression 68, Expression 79, Expression 91, Expression 93 are satisfied.

### Third Embodiment

### Form in which First Particles are Strongly Negatively Charged by One-Image Display Driving

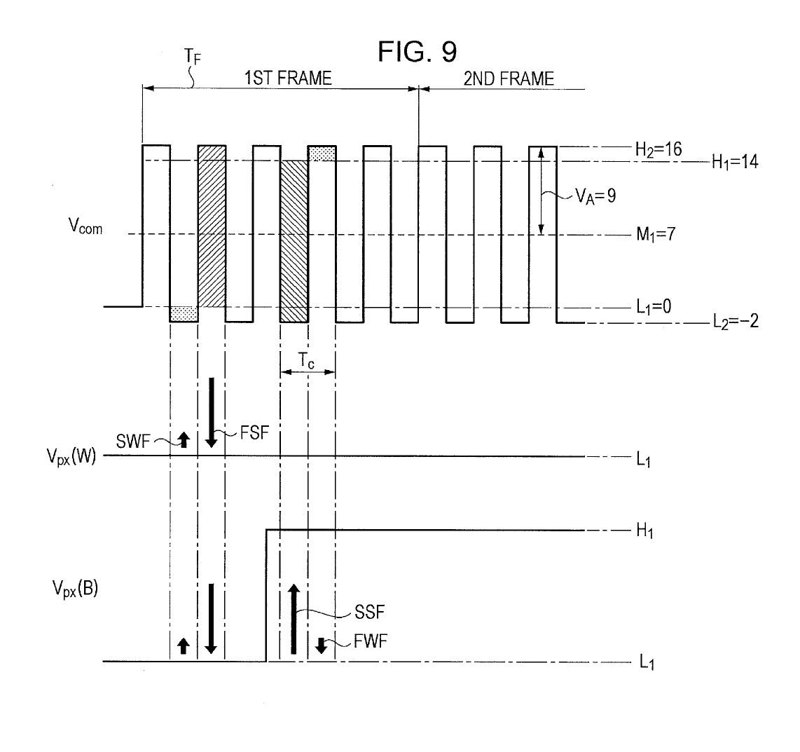

FIG. 9 is a view illustrating a method of driving an electrophoretic display device according to a third embodiment. Hereinafter, the method of driving an electrophoretic display device according to the embodiment will be described. Also, the same reference numerals designate the same components in the first embodiment, and the description thereof will not be repeated.

When the embodiment (FIG. 9) is compared with the first embodiment (FIG. 5), there is a difference in that one-image display driving is performed. The other configurations are almost the same as those of the first embodiment. In the first embodiment, the driving method is described in which the whole surface of the display unit 10 is set to the first color in the first frame period (first frame) and in which the pixels 20, which display the second color in the second frame period (second frame), are rewritten with the second color. In contrast, in the embodiment, a driving method in which the first color, the second color, or the intermediate grayscale color therebetween is displayed for each of the pixels 20 in a single frame period (one-image display), is described. The driving method is called one-image display driving.

As shown in FIG. 9, the one-image display driving is a driving method in which the first middle potential M₁ is equal to the second middle potential M₂ (M₁=M₂, therefore, hereinafter, description will be made using the first middle potential M₁) in the first embodiment, and the value of the first middle potential M₁ is the middle of the first low potential L₁ and the first high potential H₁. In order to acquire the symmetry property of the first color display and the second color display, it is preferable that the value of the first middle potential M₁ be the average value (median value) of the first low potential L₁ and the first high potential H₁. That is, it is assumed that a user views the electrophoretic display device 150 from the sides of the common electrodes 23, the first low potential L₁ is supplied to the pixels 20 which perform the first color display (Vₚₓ(W) in FIG. 9), the first high potential H₁ is supplied to the pixels 20 which perform the second color display (Vₚₓ(B) in FIG. 9), and the common potential V_{com} is alternate potential which has the amplitude V_{A} around the first middle potential M₁. At this time, the frame cycle T_{F} and the common potential cycle T_{C} are the same as in the first embodiment. The first middle potential M₁ is the average value (median value) of the first low potential L₁ and the first high potential H₁.

In this way, when the first direction (downward) is opposite to the direction of the second weak electric field SWF (upward), Expression 20 which is the white writing condition) and Expression that it is assumed that M₁=M₂ in Expression 31 which is the black writing condition are essential conditions in order to perform display. In addition, Expression 38 in which it is assumed that M₁=M₂ and which is the white-and-black symmetry condition is Expression which defines the first middle potential M₁ under the condition which is preferable to be satisfied in order to implement high durability based on potential symmetry. As shown in FIG. 9, as an example, if it is assumed that L₁=0 V, H₁=14 V and V_{A}=9 V, M₁=7 V based on Expression 38, L₂(=L₃)=−2 V and H₂(=H₃)=16 V based on Expression 11 to Expression 14, then Expression 20 and Expression 31 are satisfied.

On the other hand, when the first direction (downward) is the same as the direction of the second weak electric field SWF (downward), Expression 25 which is the white writing condition and Expression in which it is assumed that M₁=M₂ in Expression 36 which is the black writing condition are essential conditions in order to perform display. In addition, Expression 38 in which it is assumed that M₁=M₂ and which is the white-and-black symmetry condition is the Expression which defines the first middle potential M₁ under the condition which is preferable to be satisfied in order to implement high durability based on potential symmetry. As an example, if L₁=0 V, H₁=14 V and V_{A}=5 V, M₁=7 V based on Expression 38 and L₂(=L₃)=2 V and H₂(=H₃)=12 V based on Expression 11 to Expression 14, then Expression 25 and Expression 36 are satisfied.

In this manner, even in the case of the one-image display driving, the same advantage is acquired as in the first embodiment. Also, if the one-image display driving is used, when an image which is displayed is rewritten and only a part of the image is changed, it is possible to use a driving method of partially rewriting an image corresponding to the changed portion. In this case, the first middle potential M₁ is supplied to the pixels 20 which perform the same display on the first image and the second image.

### Fourth Embodiment

### Form in which First Particles are Strongly Positively Charged Using One-Image Display Driving

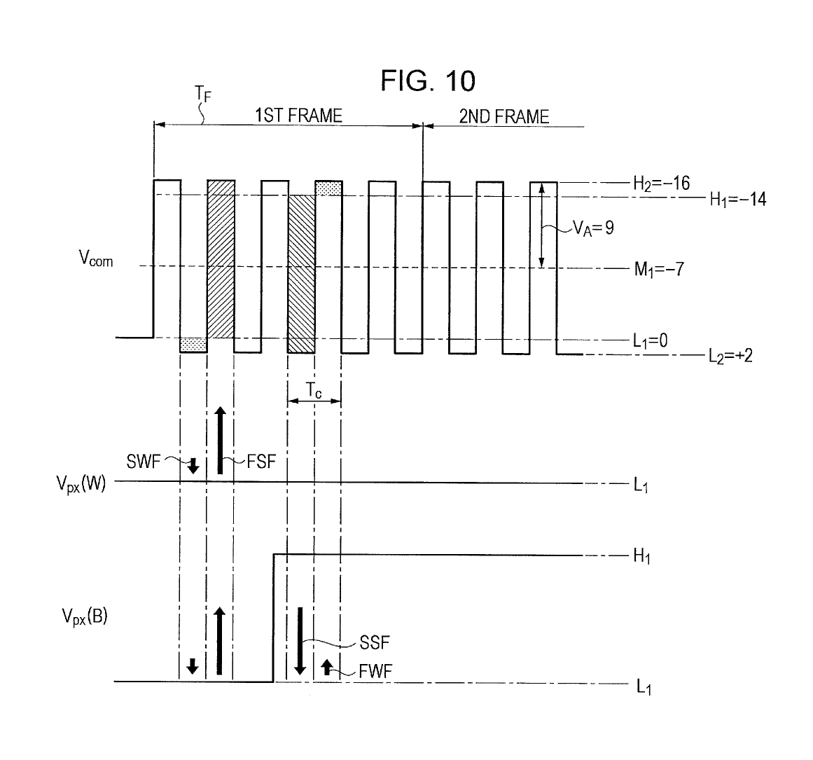

FIG. 10 is a view illustrating a method of driving an electrophoretic display device according to a fourth embodiment. Hereinafter, the method of driving an electrophoretic display device according to the embodiment will be described. Also, the same reference numerals designate the same components as in the second embodiment, and the description thereof will not be repeated.

When the embodiment (FIG. 10) is compared with the second embodiment (FIG. 8), there is a difference in that the one-image display driving is performed. The other configurations are almost the same as those of the second embodiment. In the second embodiment, there is the driving method of setting the whole surface of the display unit 10 to the first color in the first frame period (first frame) and rewriting the pixels 20, which display the second color, with the second color in the second frame period (second frame). In contrast, in the embodiment, the one-image display driving of causing each pixel 20 to display the first color, the second color, or the middle grayscale color therebetween in a single frame period (when one image is displayed) will be described.

As shown in FIG. 10, the one-image display driving is a driving method of causing the first middle potential M₁ to be equal to the second middle potential M₂ (M₁=M₂/therefore, hereinafter, description will be made using the first middle potential M₁) in the second embodiment, and causing the value of the first middle potential M₁ to be the middle of the first low potential L₁ and the first high potential H₁. In order to acquire the symmetry property of the first color display and the second color display, it is preferable that the value of the first middle potential M₁ be the average value (median value) of the first low potential L₁ and the first high potential H₁. That is, it is assumed that the user views the electrophoretic display device 150 from the sides of the common electrodes 23, the first low potential L₁ is supplied to the pixels 20 (Vₚₓ(W) in FIG. 10) which perform the first color display, the first high potential H₁ is supplied to the pixels 20 (Vₚₓ(B) in FIG. 10) which perform the second color display, and the common potential V_{com} is alternate potential which has the amplitude V_{A} around the first middle potential M₁. At this time, the frame cycle T_{F} and the common potential cycle T_{C} are the same as in the second embodiment. The first middle potential M₁ is the average value (median value) of the first low potential L₁ and the first high potential H₁.

In this way, when the first direction (upward) is opposite to the direction of the second weak electric field SWF (downward), Expression 63 which is the white writing condition and Expression in which it is assumed that M₁=M₂ in Expression 74 which is the black writing condition are essential conditions in order to perform display. In addition, Expression 81 in which it is assumed that M₁=M₂ and which is the white-and-black symmetry condition defines the first middle potential M₁ under the condition which is preferable to be satisfied in order to implement high durability based on potential symmetry. As shown in FIG. 10, as an example, if L₁=0 V, H₁=−14 V and V_{A}=9 V, M₁=−7 V based on Expression 81, L₂(=L₃)=+2 V and H₂(=H₃)=−16 V based on Expression 54 to Expression 57, then Expression 63 and Expression 74 are satisfied.

On the other hand, when the first direction (upward) is the same as the direction of the second weak electric field SWF (upward), Expression 68 which is the white writing condition, Expression in which it is assumed that M₁=M₂ in Expression 79 which is the black writing condition are essential conditions in order to perform display. In addition, Expression 81 in which it is assumed that M₁=M₂ and which is the white-and-black symmetry condition is Expression which defines the first middle potential M₁ under the condition which is preferable to be satisfied in order to implement high durability based on potential symmetry. As an example, if L₁=0 V, H₁=−14 V and V_{A}=5 V, M₁=−7 V based on Expression 81, L₂(=L₃)=−2 V and H₂(=H₃)=−12 V based on Expression 54 to Expression 57, then Expression 68 and Expression 79 are satisfied.

In this manner, even when the one-image display driving is performed, the same advantage is acquired as in the second embodiment.

Also, the invention is not limited to the above-described embodiments, and various modifications and improvements can be added to the above-described embodiments. Modification Examples will be described below.

### First Modification Example

### First Form in which Common Potential is Sine Wave

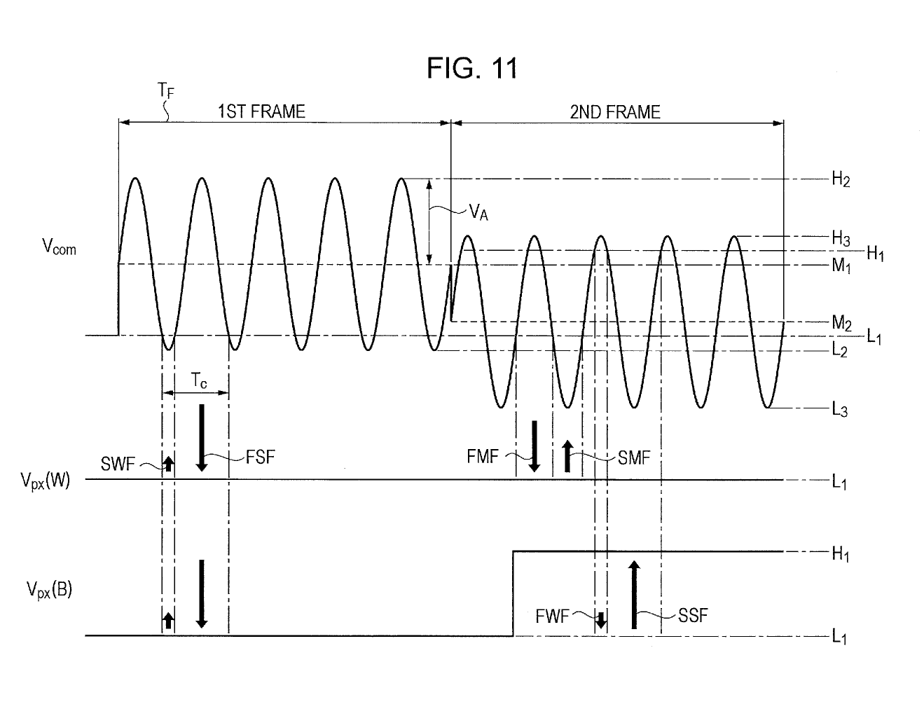

FIG. 11 is a view illustrating a method of driving an electrophoretic display device according to a first modification example. Hereinafter, a method of driving an electrophoretic display device and a control circuit according to the modification example will be described. Also, the same reference numerals designate the same components in the first embodiment and the second embodiment, and the description thereof will not be repeated.

When the modification example (FIG. 11) is compared with the first embodiment (FIG. 5), the waveform of the common potential V_{com} is different. The other configurations are almost the same as those of the first embodiment and the second embodiment. In the first embodiment (FIG. 5) and the second embodiment (FIG. 8), the common potential V_{com} is alternate potential having a square wave. However, the waveform of the common potential V_{com} is not limited thereto. For example, as shown in FIG. 11, the waveform may be a sine wave.

### Second Modification Example

### Second Form in which Common Potential is Sine Wave

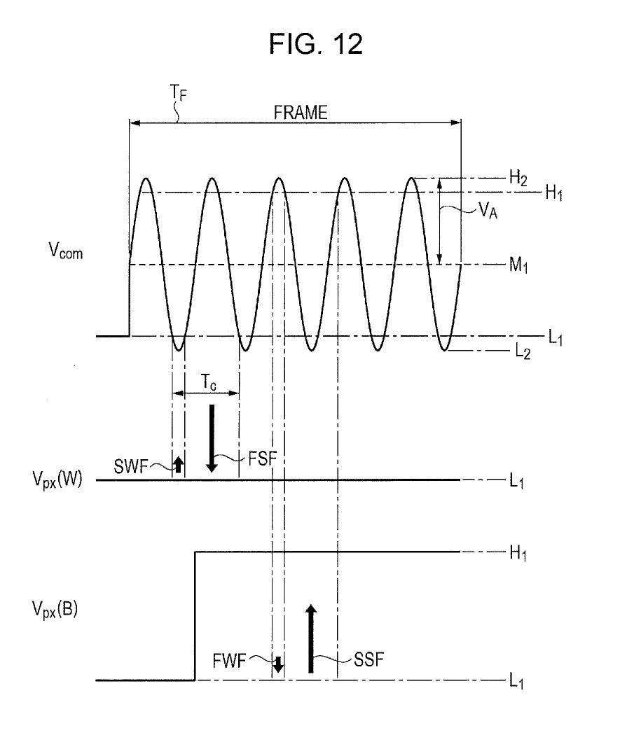

FIG. 12 is a view illustrating a method of driving an electrophoretic display device according to a second modification example. Hereinafter, the method of driving an electrophoretic display device and a control circuit according to the modification example will be described. Also, the same reference numerals designate the same components in the third embodiment and the fourth embodiment, and the description thereof will not be repeated.

When the modification example (FIG. 12) is compared with the third embodiment (FIG. 9), the waveform of the common potential V_{com} is different. The other configurations are almost the same as those of the third embodiment and the fourth embodiment. In the third embodiment (FIG. 9) and the fourth embodiment (FIG. 10), the common potential V_{com} is alternate potential having a square wave. However, the waveform of the common potential V_{com} is not limited thereto. For example, as shown in FIG. 12, the waveform may be a sine wave.

### Third Modification Example

### Form in which Common Potential has Other Waveform

In the first to fourth embodiments, the alternate electric field has a square wave, and in the first and second modification examples, the alternate electric field has a sine wave. The waveform of the alternate electric field is not limited thereto, and various forms can be used. For example, the alternate electric field may have a trapezoid wave, a chopping wave, or a saw tooth wave. When the alternate electric field is formed, the common potential V_{com} is the alternate potential of the trapezoid wave, the chopping waves, or the saw tooth wave.

This application claims the benefit of Japanese Patent Application No. 2013-028667, filed on Feb. 18, 2013, which is hereby incorporated by reference as if fully set forth herein.

What is claimed is:

1. A method of driving an electrophoretic display device that includes pixel electrodes, common electrodes, and an electrophoretic material to which electric fields generated between the pixel electrodes and the common electrodes are applied, and that displays at least a first color and a second color,
wherein the electrophoretic material includes first particles which show the first color and second particles which show the second color, at least one side of the first particles and the second particles being charged with positive polarity or negative polarity,
wherein, when the first particles are dispersed on sides of the common electrodes, the electric fields which are generated between the pixel electrodes and the common electrodes include a first electric field which faces a first direction and a second electric field which is weaker than the first electric field, the first electric field and the second electric field being alternately repeated at a common potential cycle T_{c},
wherein, when the second particles are dispersed on sides of the common electrodes, the electric fields which are generated between the pixel electrodes and the common electrodes include a third electric field which faces a second direction opposite to the first direction and a fourth electric field which is weaker than the third electric field, the third electric field and the fourth electric field being repeated at the common potential cycle T_{c}, and
wherein the first electric field, the second electric field, the third electric field, and the fourth electric field are formed by supplying alternate potential to the common electrodes at the common potential cycle T_{c}.

2. The method of driving an electrophoretic display device according to claim 1,
wherein, when it is assumed that a period in which one frame image is formed is a frame cycle T_{F}, the common potential cycle T_{c} is shorter than the frame cycle T_{F}.

3. The method of driving an electrophoretic display device according to claim 1,
wherein an orientation of the second electric field is the second direction, and an orientation of the fourth electric field is the first direction.

4. The method of driving an electrophoretic display device according to claim 1,
wherein an orientation of the second electric field is the first direction, and an orientation of the fourth electric field is the second direction.

5. The method of driving an electrophoretic display device according to claim 3,
wherein the first particles are charged with negative polarity rather than the second particles, and
wherein first low potential L₁ is supplied to the pixel electrodes when the first particles are dispersed in vicinity of the common electrodes, and a relational expression of Expression 1 is satisfied when it is assumed that a central potential of the alternate potential is first middle potential M₁ and an amplitude of the alternate potential is an amplitude V_{A}.
0<M₁−L₁<V_{A} (1)

6. The method of driving an electrophoretic display device according to claim 3,
wherein the first particles are charged with positive polarity rather than the second particles, and
wherein first low potential L₁ is supplied to the pixel electrodes when the first particles are dispersed in vicinity of the common electrodes, and a relational expression of Expression 2 is satisfied when it is assumed that a central potential of the alternate potential is first middle potential M₁ and an amplitude of the alternate potential is an amplitude V_{A}.
0<L₁−M₁<V_{A} (2)

7. The method of driving an electrophoretic display device according to claim 4,
wherein the first particles are charged with negative polarity rather than the second particles, and
wherein first low potential L₁ is supplied to the pixel electrodes when the first particles are dispersed in vicinity of the common electrodes, and a relational expression of Expression 3 is satisfied when it is assumed that a central potential of the alternate potential is first middle potential M₁ and an amplitude of the alternate potential is an amplitude V_{A}.
0<V_{A}<M₁−L₁ (3)

8. The method of driving an electrophoretic display device according to claim 4,
wherein the first particles are charged with positive polarity rather than the second particles, and
wherein first low potential L₁ is supplied to the pixel electrodes when the first particles are dispersed in vicinity of the common electrodes, and a relational expression of Expression 4 is satisfied when it is assumed that a central potential of the alternate potential is first middle potential M₁ and an amplitude of the alternate potential is an amplitude V_{A}.
0<V_{A}<L₁−M₁ (4)

9. The method of driving an electrophoretic display device according to claim 5,
wherein first high potential H₁ is supplied to the pixel electrodes when the second particles are dispersed in vicinity of the common electrodes, and a relational expression of Expression 5 is satisfied when it is assumed that a central potential of the alternate potential is second middle potential M₂.
0<H₁−M₂<V_{A} (5)

10. The method of driving an electrophoretic display device according to claim 6,
wherein first high potential H₁ is supplied to the pixel electrodes when the second particles are dispersed in vicinity of the common electrodes, and a relational expression of Expression 6 is satisfied when it is assumed that a central potential of the alternate potential is second middle potential M₂.
0<M₂−H₁<V_{A} (6)

11. The method of driving an electrophoretic display device according to claim 7,
wherein first high potential H₁ is supplied to the pixel electrodes when the second particles are dispersed in vicinity of the common electrodes, and a relational expression of Expression 7 is satisfied when it is assumed that a central potential of the alternate potential is second middle potential M₂.
0<V_{A}<H₁−M₂ (7)

12. The method of driving an electrophoretic display device according to claim 8,
wherein first high potential H₁ is supplied to the pixel electrodes when the second particles are dispersed in vicinity of the common electrodes, and a relational expression of Expression 8 is satisfied when it is assumed that a central potential of the alternate potential is second middle potential M₂.
0<V_{A}<M₂−H₁ (8)

13. The method of driving an electrophoretic display device according to claim 9,
wherein the first middle potential M₁ is equal to the second middle potential M₂.

14. The method of driving an electrophoretic display device according to claim 1,
wherein the electrophoretic display device includes storage capacity elements,
wherein the storage capacity elements each include first electrodes and second electrodes, and the first electrodes are electrically connected to the pixel electrodes,
wherein capacity (EPD capacity C_{E}), which is formed of the pixel electrodes, the common electrodes, and the electrophoretic material, is sufficiently smaller than capacity (storage capacity C_{S}) of the storage capacity element, and
wherein potential of the second electrodes is fixed.

15. A control circuit of an electrophoretic display device, which performs the driving method according to claim 1.

16. A control circuit of an electrophoretic display device, which performs the driving method according to claim 2.

17. A control circuit of an electrophoretic display device, which performs the driving method according to claim 3.

18. A control circuit of an electrophoretic display device, which performs the driving method according to claim 4.

19. An electrophoretic display device comprising the control circuit according to claim 15.

20. An electronic apparatus comprising the electrophoretic display device according to claim 19.
